(19) United States
(12) Patent Application Publication
(10) Pub. No.: US 2024/0242471 A1
(43) Pub. Date: Jul. 18, 2024

(54) AUTHENTICATING VIDEO

(71) Applicant: NEC Corporation Of America, Herzlia (IL)

(72) Inventor: Tsvi LEV, Tel-Aviv (IL)

(73) Assignee: NEC Corporation Of America, Herzlia (IL)

(21) Appl. No.: 18/098,166

(22) Filed: Jan. 18, 2023

(51) Int. Cl. G06V 10/60; G06F 21/64

(52) U.S. Cl. CPC G06V 10/60; G06F 21/645

(57) ABSTRACT

A method of authenticating video, comprising using a computing device of a receiving party, for: receiving a video showing a light pattern being projected onto an area captured in the video, the video being associated with a time point, extracting the light pattern from the received video, and verifying authenticity of the received video based on the extracted light pattern, on a reference light pattern identifier, and on a time difference between a time of receipt of the video by the receiving party and the time point.

### FIELD AND BACKGROUND OF THE INVENTION

The present invention relates to video communication technologies, and more particularly, but not exclusively, to a method and a system for authenticating video.

With nowadays advanced video editing technology, it has become increasingly important to assure the authenticity and trustworthiness of videos communicated between parties or broadcast (say videos broadcast live over the internet).

Indeed, in many fields, videos communicated between two or more parties or broadcast to large audiences, need to be protected against attempts to manipulate them, as potentially, such malicious alterations could affect decisions made based on the videos, change public opinion, manipulate stock markets, etc.

For example, deep faking uses deep learning technology to create fake videos.

Deep learning technology is a kind of machine learning that applies Artificial Intelligence (AI) methods such as neural network simulation, to massive data sets, so as to create fake videos.

For example, a neural network may be trained to effectively learn what a particular face (say the face of a famous politician) looks like at different angles, in order to transpose the face onto a target as if it were a mask.

As a result, for example, a live video that shows a person speaking to an audience, may be manipulated, by such masking, to show the famous politician speaking rather than the person originally captured in the video.

In another example, with currently available deep fake technologies, a video of a politician may be manipulated, so as to show the politician kissing and hugging with a famous actress.

Similarly, deep faking of voice, also known in the art as voice cloning or synthetic voice generation, uses AI technologies to generate a clone of a person's voice (say a famous politician, actor or other public figure), such that another person may speak with the voice of the person whose voice is cloned. Indeed, voice deep fake technology has advanced to the point that it can closely replicate a human voice with great accuracy in tone and likeness.

Thus, for example, deep-faked voice generation and deep-faked masking may be used together, to create a fake video of the US President giving a speech on TV, so as to show the president saying things that the president never said or even intended to say.

As a result, the president's public image, relationship with other world leaders or with political allies and opponents, the stock market, election results, etc., may be manipulated, to serve the interests of the parties behind the manipulation.

In one example, in kind of a “man-in-the-middle” attack, an attacker may relay and alter communication between a sender and a recipient of a video.

In the example, the attacker intercepts the video, and uses deep fake technologies, to change the video or replace the video with a faked one, so as to show a faked president speech, in which faked speech, the president makes an announcement on major cuts in defense expenses. As a result, stock markets may be manipulated, such that defense constructor securities fall.

In another example, deep fake may be used for visually flawless editing of surveillance imagery that nowadays, has become readily available through the proliferation of residential networks, doorbell cameras, and other internet-based security systems. The cloud nature of such cameras makes them very vulnerable to remote manipulation while their residential installations make direct tampering far easier than guarded commercial installations.

Surveillance deep fakes could be customized to the exact camera whose footage is to be altered, with a model trained to perfectly replicate its noise patterns and visual artifacts.

Such sensor customization would make traditional detection methods such as artifact analysis useless, as the resulting faked footage would replicate the response characteristics of that specific physical camera sensor nearly perfectly.

### SUMMARY OF THE INVENTION

According to a first aspect of the present invention, there is provided a method of authenticating video, comprising using a computing device of a receiving party, for: receiving a video showing a light pattern being projected onto an area captured in the video, the video being associated with a time point, extracting the light pattern from the received video, and verifying authenticity of the received video based on the extracted light pattern, on a reference light pattern identifier, and on a time difference between a time of receipt of the video by the receiving party and the time point

According to a second aspect of the present invention, there is provided a system for authenticating video, the system implemented on a computing device of a receiving party and comprising: a processing circuitry, and a memory in communication with the processing circuitry, the memory containing instructions that, when executed by the processing circuitry, cause the system to: receive a video showing a light pattern being projected onto an area captured in the video, the video being associated with a time point, extract the light pattern from the received video, and verify authenticity of the received video based on the extracted light pattern, on a reference light pattern identifier, and on a time difference between a time of receipt of the video by the receiving party and the time point.

According to a third aspect of the present invention, there is provided a non-transitory computer readable medium having stored thereon instructions for causing a processing circuitry of a computing device of a receiving party to perform a process of authenticating video, the process comprising: receiving a video showing a light pattern being projected onto an area captured in the video, the video being associated with a time point, extracting the light pattern from the received video, and verifying authenticity of the received video based on the extracted light pattern, on a reference light pattern identifier, and on a time difference between a time of receipt of the video by the receiving party and the time point.

According to a fourth aspect of the present invention, there is provided a method of authenticating video, the method comprising steps performed by a computing device of a sending party, the steps comprising: obtaining a reference light pattern identifier, the light pattern identifier identifying a light pattern, using a light source in communication with the computing device of the sending party, generating and projecting the light pattern identified by the obtained light pattern identifier, onto an area covered by a camera, using the camera, capturing the area while being projected with the light pattern in a video, and sending the video to a receiving party.

According to a fifth aspect of the present invention, there is provided a system for authenticating video, the system implemented on a computing device of a sending party and comprising: a processing circuitry, and a memory in communication with the processing circuitry, the memory containing instructions that when executed by the processing circuitry, cause the system to: obtain a reference light pattern identifier, the light pattern identifier identifying a light pattern, using a light source in communication with the computing device of the sending party, generate and project the light pattern identified by the obtained light pattern identifier onto an area covered by a camera, using the camera, capture the area while being projected with the light pattern in a video, and send the video to a receiving party.

According to a sixth aspect of the present invention, there is provided a non-transitory computer readable medium having stored thereon instructions for causing a processing circuitry of a computing device of a sending party to perform a process of authenticating video, the process comprising: obtaining a reference light pattern identifier, the light pattern identifier identifying a light pattern, using a light source in communication with the computing device of the sending party, generating and projecting the light pattern identified by the obtained light pattern identifier, onto an area covered by a camera, using the camera, capturing the area while being projected with the light pattern in a video, and sending the video to a receiving party.

According to a seventh aspect of the present invention, there is provided a method of authenticating video, the method comprising steps performed by a server computer, the steps comprising: from a computing device of a first party, receiving a first request for an identifier, the identifier identifying a light pattern, selecting an identifier for the first party, based on the received first request, providing the computing device of the first party with the selected identifier, for the first party to use for generating and projecting the light pattern onto an area while being captured in a video, from a computing device of a second party, the second party being in receipt of the video, receiving a second request for the identifier, selecting the same identifier for the second party, based on the received second request, and providing the computing device of the second party with the selected identifier, for the second party to use for verifying authenticity of the video.

According to an eighth aspect of the present invention, there is provided a system for authenticating video, the system implemented on a server computer and comprising: a processing circuitry, and a memory in communication with the processing circuitry, the memory containing instructions that, when executed by the processing circuitry, cause the system to: from a computing device of a first party, receive a first request for an identifier, the identifier identifying a light pattern, select an identifier for the first party, based on the received first request, provide the computing device of the first party with the selected identifier, for the first party to use for generating and projecting the light pattern onto an area while being captured in a video, from a computing device of a second party, the second party being in receipt of the video, receive a second request for the identifier, select the same identifier for the second party, based on the received second request, and provide the computing device of the second party with the selected identifier, for the second party to use for verifying authenticity of the video.

According to a ninth aspect of the present invention, there is provided a non-transitory computer readable medium having stored thereon instructions for causing a processing circuitry of a server computer to perform a process of authenticating video, the process comprising: from a computing device of a first party, receiving a first request for an identifier, the identifier identifying a light pattern, selecting an identifier for the first party, based on the received first request, providing the computing device of the first party with the selected identifier, for the first party to use for generating and projecting the light pattern onto an area while being captured in a video, from a computing device of a second party, the second party being in receipt of the video, receiving a second request for the identifier, selecting the same identifier for the second party, based on the received second request, and providing the computing device of the second party with the selected identifier, for the second party to use for verifying authenticity of the video.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof.

Moreover, according to actual instrumentation and equipment of preferred embodiments of the method and system of the present invention, several selected steps could be implemented by hardware or by software on any operating system of any firmware or a combination thereof.

For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE SEVERAL VIEWS OF THE DRAWINGS

The invention is herein described, by way of example only, with reference to the accompanying drawings.

With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. The description taken with the drawings making apparent to those skilled in the art how the several forms of the invention may be embodied in practice.

In the drawings:

FIG. 1 is a flowchart schematically illustrating a first method of authenticating video, according to an exemplary embodiment of the present invention.

FIG. 2 is a flowchart schematically illustrating a second method of authenticating video, according to an exemplary embodiment of the present invention.

FIG. 3 is a flowchart schematically illustrating a third method of authenticating video, according to an exemplary embodiment of the present invention.

FIG. 4 is a simplified block diagram schematically illustrating a first exemplary system for authenticating video, according to an exemplary embodiment of the present invention.

FIG. 5 is a simplified block diagram schematically illustrating a second exemplary system for authenticating video, according to an exemplary embodiment of the present invention.

FIG. 6 is a simplified block diagram schematically illustrating a third exemplary system for authenticating video, according to an exemplary embodiment of the present invention.

FIG. 7 is a simplified block diagram schematically illustrating a first exemplary non-transitory computer readable medium having stored thereon instructions for causing a processing circuitry to perform a process of authenticating video, according to an exemplary embodiment of the present invention.

FIG. 8 is a simplified block diagram schematically illustrating a second exemplary non-transitory computer readable medium having stored thereon instructions for causing a processing circuitry to perform a process of authenticating video, according to an exemplary embodiment of the present invention.

FIG. 9 is a simplified block diagram schematically illustrating a third exemplary non-transitory computer readable medium having stored thereon instructions for causing a processing circuitry to perform a process of authenticating video, according to an exemplary embodiment of the present invention

### DESCRIPTION OF THE PREFERRED EMBODIMENTS

The present embodiments comprise a method and a system for authenticating video.

As discussed in further detail hereinabove, with nowadays advanced video editing technologies available to malicious parties, it has become increasingly important to assure authenticity and trustworthiness of videos communicated between two or more parties.

Thus, in many fields (Surveillance, On-line video conferences, live TV broadcasting, etc.) video contents communicated between two or more parties, would need to be protected against attempts to manipulate the video contents, say with deep fake technologies, etc., as described in further detail hereinabove.

Indeed, such malicious video manipulation may affect decisions made based on the manipulated videos, manipulate public opinion, manipulate stock markets (say a specific security's value), affect national security, etc, as described in further detail hereinabove.

Exemplary embodiments of the present invention aim at authenticating a video (say a live video) communicated between two or more parties, using a light pattern projected onto a physical area captured in the video, and optionally, further using a time limit, say a limit that reflects the time that would be needed for manipulating the video effectively, as described in further detail hereinbelow.

The light pattern is generated based on a light pattern identifier—say a key or index that identifies the light pattern, a file that the light pattern is encoded in, a text (say character string) that the light pattern in encrypted in, etc., or any combination thereof, as described in further detail hereinbelow.

Optionally, the light pattern identifier is generated and/or selected by a third party that is trusted by both a party who sends the video (i.e. the sending party) and a party who receives the video (i.e. a receiving party), as described in further detail hereinbelow.

Thus, in one example, the light pattern identifier is obtained from a server computer that is remote from the parties (say from a computer server of the trusted third party), as described in further detail hereinbelow.

In the example, the server computer is queried by the sending party, for obtaining the light pattern identifier, in order to base generating of the light pattern on the identifier.

Later, the server computer may be queried by the receiving party too, when the video is received by the receiving party, for obtaining the light pattern identifier.

The receiving party uses the obtained light pattern identifier, for verifying authenticity of the video, as described in further detail hereinbelow.

Optionally, the light pattern identifier is rather selected and/or generated by one or more identifier selector(s) (say an identifier selector implemented on a mobile phone, desktop or other computing device).

Each one of the selector(s) is provided to a respective one of the parties, by a same trusted third party (say vendor), but is used locally by the respective party, as described in further detail hereinbelow.

The identifier selectors provided to the parties are functionally identical. That is to say that the selectors are configured (say programmed) by the trusted third party, to provide (i.e. output) a same light pattern identifier upon a same input. Thus, each first one of the light pattern identifier selectors, outputs the same light pattern identifier as a second one of the selectors when input the same data (say the same data point) as the first selector, as described in further detail hereinbelow.

As the light pattern that appears in the video depends on the light pattern identifier selected by the trusted third party (whether by the server computer or rather, by the locally used identifier selector), the light pattern serves as a kind of a certificate that is usable for verifying authenticity and trustworthiness of the video, as described in further detail hereinbelow.

Optionally, the generation and/or selection of the light pattern identifier is/are rather based on a formula or method that the sending party and the receiving party agree upon in advance of video communication between the two or more parties.

The formula or method is known only to the parties or rather, to both the parties and one or more other parties trusted by the sending parties (say other potential recipients of the video), as described in further detail hereinbelow.

Optionally, the server computer is operated by the trusted third party that provides a service of generating and/or selecting of light pattern identifiers for different parties or another third party that is an entity trusted by both the sending party and the receiving party, as described in further detail hereinbelow.

Optionally, the light pattern identifier is a time-dependent identifier that is obtained in turn, by each one of two or more parties to a communication of a live video between the two or more parties.

Thus, in one case, a trusted third party's server computer is queried for the light pattern identifier, using data that identifies a time point associated with the video (say using a timestamp embedded in the video, a known time of broadcast of the video, etc). The light pattern identifier is thus selected for the party, by the server computer, according to the time point associated with the video, as described in further detail hereinbelow.

In a second case, the server computer selects and/or generates the light pattern identifier according to a time (say the hour, minute and second) of the very querying of the server computer by the party.

In the second case, the server computer is rather programmed in advance to change the identifier that is selected and/or generated, every period of time (say every sixty seconds), the length of which period is defined in advance by a programmer, operator or user of the server computer, as described in further detail hereinbelow.

In the second case, a same, first light pattern identifier that encodes a respective light pattern, is provided by the server computer to any party who queries the server computer during a first time period (say between 18:00:01 and 18:01:00). However, a second, different light pattern identifier is provided by the server computer when queried in a second time period (say during the next sixty seconds, i.e. between 18:01:01 and 18:02:00).

Optionally, in the second case, the length of the time period is set in advanced by programmer, operator or user of the server computer, so as to reflect the time that would be needed to manipulate the video effectively, as described in further detail hereinbelow.

In a second example, the light-pattern identifier is a time-dependent identifier that is obtained by the party, using a time-based light pattern identifier selector (say an application installed on the party's computing device) that is used locally by the party, as described in further detail hereinbelow.

In the second example, the light pattern identifier is selected and/or generated for the party by the time-based light pattern identifier selector used locally by the party, per a request input to the light pattern identifier by the party, which request includes data that indicates the time point associated with the video.

Optionally, the light pattern identifier selector is provided in advance to the party, say by a vendor or other third party, trusted by both a party who captures and sends the video and a party who receives the video, as described in further detail hereinabove.

Thus, in the two examples described hereinabove, the light pattern identifier, and hence the light pattern, is selected for the party automatically, upon the party's request, based on time.

Optionally, the authenticating of the video is further based on a time limit.

For example, a finding of the video to be an authentic one, may be further conditioned upon verifying that a time difference between the video's time of receipt by a receiving party and the time point associated with the video (say a time indicated in a timestamp of the video or a known time of broadcast of the video) is within a predefined limit.

The limit may be defined by a user, operator or programmer of the system(s) describe hereinbelow, say based on an estimated time it would take a malicious party to replace the video with a faked video that mimics the originally sent video's background and/or visual objects, as described in further detail hereinbelow.

Thus, according to an exemplary embodiment, both the light pattern and the time difference between the time point associated with the video and video's time of receipt are used together for verifying authenticity and trustworthiness of the video, as described in further detail hereinbelow.

The principles and operation of a system according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

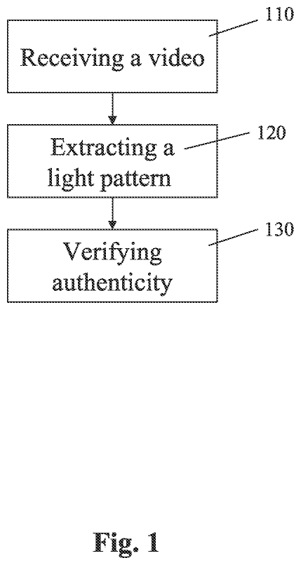

Reference is now made to FIG. 1, which is a flowchart schematically illustrating a first method of authenticating video, according to an exemplary embodiment of the present invention.

A first exemplary method of authenticating video, according to an exemplary embodiment of the present invention, may be executed by a computing device of a receiving party that receives a video (say a live video) sent or broadcast by a sending party, as described in further detail hereinbelow.

The receiving party's computing device may be a single computer (say an internet-connected streaming device, a smart TV set, a smart cellular phone, a laptop or other computer, etc.), a group of computers in communication over a network, a computer circuitry that includes one or more electric circuits, a computer processor and a computer memory, etc., or any combination thereof, as described in further detail hereinbelow.

Thus, in one example, the first method is executed by a system that includes a circuit (say an integrated electric circuit (IC)), say by system 4000, as described in further detail hereinbelow.

The circuit of the example includes one or more computer processors, one or more computer memories (say a DRAM (Dynamic Random Access Memory) component, an SRAM (Static Random Access Memory) component, an SSD (Solid State Drive) component, etc.), one or more other components, etc., or any combination thereof, as described in further detail hereinbelow.

The computer memory stores instructions, say instructions that are executable by one or more of the system's 4000 computer processor(s), for performing the steps of the first method, as described in further detail hereinbelow.

In the first method, there is received 110 a video, say by the video receiver 411 of system 4000, as described in further detail hereinbelow.

The received 110 video shows a light pattern projected onto an area captured in the received 110 video (usually, together with one or more other objects, say a person, a car, a door, an audience, etc.), say onto a wall, a curtain, a surveillance area (say a parking lot), a stand, a computer screen, a TV screen, etc.

Optionally, the light pattern is dynamic. For example, the light pattern's color, shape or both the pattern's color and the pattern's shape, may change between at least two frames of the received 110 video. Alternatively, the light pattern is rather a static pattern that looks the same through all the received 110 video's frames that the light pattern appears in.

In one example, the received 110 video is a video of the US President, which video is captured as the president gives a live speech on television (TV).

In the example, the received 110 video shows the light pattern projected onto a physical area that is in the background or foreground of the president, onto an area of an object that stands beside the president, etc.

The physical area of the example may be, for example, a frontal face of a podium used by the president during the speech, a wall or curtain that the president stands before during the speech, a board positioned beside the president during the speech, a computer screen that displays the pattern during the speech, etc.

Optionally, the light pattern is generated based on a light pattern identifier, say based on a reference light pattern identifier obtained from a computer server of a third party trusted by both the sending party and the receiving party, as described in further detail hereinbelow.

The received 110 video is associated with a time point.

The time point may be, for example, a time point (say day, hour, minute and second) that marks the time (say start or end) of the received 110 video's filming by the sending party, and that is indicated in a timestamp embedded in the received 110 video, as described in further detail hereinbelow.

The time point may also be, for example, the received 110 video's known time of live broadcast, the point in time at which that the video is received 110 by the receiving party, etc., as described in further detail hereinbelow.

The time point may also be, for example, a time point received from a source of the received 110 video (say the video's sending party) or from another source trusted by the receiving party (say a third party trusted by both the receiving party and the sending party), etc., as described in further detail hereinbelow.

Next, the light pattern is extracted 120 from the received 110 video, say by the light pattern extractor 412 of system 4000, as described in further detail hereinbelow.

Optionally, the light pattern is extracted 120 from the received 110 video, using one or more methods of image processing. The image processing methods may include, but are not limited to object detection and recognition methods, object flow evaluation methods, AI (Artificial Intelligence) based feature mapping methods, AI based segmentation methods, object cropping methods, etc., as known in the art.

For example, the light pattern may be extracted 120 using one or more of the many tools nowadays available commercially from vendors such as Google™, Amazon™, Microsoft™, and other vendors.

Optionally, the light pattern is extracted 120 into one or more video frames that show(s) only the light pattern, say into video frames in which all frame pixels but the pixels occupied by the extracted 120 light pattern are darkened.

Optionally, the light pattern is extracted 120 into a motional graphical file or into a file of another graphical or non-graphical format, as described in further detail hereinbelow.

Optionally, the light pattern is extracted 120 into a file of an agreed-upon standard (say a graphical file of a specific type and/or structure), as described in further detail hereinbelow.

Next, there is verified 130 authenticity of the received 110 video, based on the extracted 120 light pattern and a reference light pattern identifier, say by the receiving party's system of video authentication, say by the video authenticator 413 of system 4000, as described in further detail hereinbelow.

Optionally, the authenticity of the received 110 video is verified 130 by extracting a light pattern identifier from the light pattern extracted 120 from the received 110 video, and comparing the extracted light pattern identifier with a reference light pattern identifier. Thus, unless the identifier extracted from the extracted 120 light pattern and the reference light pattern identifier are the same, the received 110 video is not found to be authentic.

Optionally, the authenticity of the received 110 video is rather verified 130 by selecting a second light pattern from a database of light patterns (say a database that is accessible on the trusted party's server computer) and/or generating the second light pattern based on the reference light pattern.

Then, the second light pattern is compared with the light pattern extracted 120 from the received 110 video, say using a computer application that uses one or more image processing methods, as described in further detail hereinabove. Optionally, the computer application is provided to the receiving party by the trusted third party in advance of the receipt 110 of the video, as described in further detail hereinbelow.

Optionally, each one of the light pattern identifier and the reference light pattern identifier is a key or index that identifies the light pattern, as described in further detail hereinbelow.

Optionally, each one of the light pattern identifier and the reference light pattern identifier is a file that the light pattern is encoded in, a text (say character string) that the light pattern in encrypted in, etc., as described in further detail hereinbelow.

In a first example, the receiving party's computing device obtains the reference light pattern identifier, by querying a server computer of a third party who is trusted by both the receiving party and the sending party, for the reference light pattern identifier, as described in further detail hereinbelow.

Earlier, at the sending party's end, the light pattern is generated (say by the sending party's computing device) based on the reference light pattern identifier, captured in the video, and sent by the sending party's computing device to the receiving party's computing device, as described in further detail hereinbelow.

In the first example, the sending party too, obtains the reference light pattern identifier, by querying the trusted third party's server computer, before generating the light pattern based on the reference light pattern, and projecting the light pattern onto the area captured in the video, as described in further detail hereinbelow.

In the first example, the server computer selects and/or generates the reference light pattern identifier, upon receiving a query from one of the parties, and provides the identifier to the party that the query is sent by.

Optionally, the server computer selects and/or generates the light pattern identifier according to a time point indicated in data that the server computer receives from the party as a part of the querying, such that the identifier would be the same for all parties who query the server computer with a same time point, as described in further detail hereinbelow.

In a second example, the light pattern identifier is rather selected and/or generated by one or more identifier selector(s), each of which selector(s) is used locally by a respective one the parties.

Optionally, the identifier selector is implemented as an application provided by a third party (say vendor) that is trusted by both the sending party and the receiving party, as a dedicated computing device provided by the trusted third party to the parties, etc., as described in further detail hereinbelow.

Thus, in one example, the application is installed on a computing device (say a laptop computer, a smart cellular phone, etc.) in general use by the party, whereas in another example, the application is rather installed on a dedicated computing device (say a dongle, a tablet computer, etc.) provided to the party by the trusted third party, as described in further detail hereinbelow.

Optionally, the trusted third party (say a vendor trusted by each one of the parties that the video is communicated between) provides the application and/or the dedicated computing device, that implement the light pattern identifier selector, in advance of video communication between the parties. The light pattern identifier selector is programmed by the trusted party (say by the vendor's computer programmers), to generate and/or select the identifier per a request, when the request is input to the identifier selector by one of the parties.

Optionally, the identifier selector is a time based identifier selector.

In one example, the time base identifier selector selects and/or generates the light pattern identifier according to data that pertains to a time point (say a time point indicated in a timestamp embedded in the video, as known in the art), which data is input to the identifier selector.

In the example, the light pattern identifier would be the same for each party in possession of the identifier selector when input data (i.e. data that makes up at least a part of the request) that indicates the same time point, as described in further detail hereinbelow.

In another example, the identifier selector selects and/or generates the light pattern identifier based on a time of use of the identifier selector (i.e. based on the time point (say day, hour and minute)) that a request to provide the identifier is input to the identifier selector at, as described in further detail hereinbelow.

Optionally, in the other example, the selected/generated identifier would be the same for each party in possession of one of the identifier selector(s), when the identifier selector is used at a point of time that is within a same time frame, as defined by a programmer of the identifier selector, as described in further detail hereinbelow.

Optionally, the generation and/or selection of the reference light pattern identifier is/are rather based on a formula or method that the sending party and the receiving party agree upon in advance of video communication between the two or more parties.

Optionally, the formula or method is known only to the parties or rather, to both the parties and one or more other parties trusted by the sending parties (say other potential recipients the video), and is implemented by a computer application that runs locally on each respective party's computing device, or rather, on a computer that is accessible to both parties, as described in further detail hereinbelow.

Thus, for example, the sending party and the receiving party may agree to use the same encryption/decryption formula(s) for extracting 120 the light pattern identifier from the light pattern at the receiving party's end, and for generating 220 the light pattern at the sending party's end, as described in further detail hereinbelow. Optionally, the verifying 130 is further based on a time limit.

For example, the verifying 130 may further include verifying that a time difference between a time of receipt 110 of the video by the receiving party and the time point (say the time point indicated in a timestamp embedded in the received 110 video or rather, a time point that is the video's known time of broadcast) is within a predefined limit.

Optionally, the limit is predefined in advance of the video's communication between the sending party and the receiving party, say by a user, operator or programmer of the a system that implements the method (say system 4000).

Thus, in one example, the user, operator or programmer sets the limit (say a one minute limit) based on an estimated minimal duration of time that a malicious party would need, in order to replace the video, before the video is received 110 by the receiving party, with a faked video that shows similar background and/or objects as the originally sent video, as described in further detail hereinbelow.

In the example, if the time difference between a time of receipt 110 of the video by the receiving party and the time point (say the time point indicated in the timestamp that) exceeds the time limit (say one minute), the received 110 video is found to be faked rather than authentic.

Optionally, the light pattern identifier is based on an encryption function applied on the light pattern after the pattern is designed by an artist, or other designer, and stored in a database that may be provided or made accessible to the sending party, the receiving party, or both (say on a database stored on the trusted third party's server computer), as described in further detail hereinbelow.

Optionally, the light pattern identifier is based on a random or a non-random key that the designer associates with the light pattern, etc., or any combination thereof, as described in further detail hereinbelow.

In one example, the sending party captures a live video, say of a speech given by a politician, and sends the live video to the receiving party (say to a TV station that intends to broadcast the live video to a large audience). In the example, the light pattern is projected onto an area captured in the live video (say onto a podium used by the politician when captured in the video).

In the example, the light pattern is selected from a set of light patterns (say from a database of motional graphical files or of other graphical files, as known in the art), based on a light-pattern identifier. The set (say the database) may be installed on the sending party's computing device (say a mobile phone, a laptop, tablet computer) or other computer, as described in further detail hereinbelow.

In the example, the light-pattern identifier itself is obtained from a remote server or rather, from an identifier selector operated locally by the sending party, etc., based on data that indicates a time point associated with the video, as described in further detail hereinabove.

In one example, one light-pattern identifier is a key (say ‘A0001’) that identifies a first light pattern of the set (say a first one of the files), whereas a second light-pattern identifier is a key (say ‘A0002’) that identifies a second one of the set's light patterns. Thus, in the example, the light pattern identifier is an index that uniquely identifies a specific light pattern (say by identifying a specific one of the motional graphical files).

In the example, the sending party who captures the video, holds a copy of the set of light patterns (say of the database of the motional graphical files) or rather, is allowed to access the set of light patterns on a remote computer (say the remote computer of the trusted third party, or of a light pattern designer, etc.).

In the example, the sending party selects the light pattern from the set (say by retrieving the file that holds the light pattern from the database), based on the light pattern identifier, as described in further detail hereinbelow.

Then, the sending party uses her computing device and one or more light source(s) that is/are in communication with the party's computing device, to project the selected (say retrieved) light pattern onto the area when captured by the party using a video camera, as described in further detail hereinbelow.

The light source may be external to the party's computing device (say a projector, computer screen, or other external light source), internal to the party's computing device (say the computing device's own screen or other light source), etc., or any combination thereof.

In a second example, a sending party rather queries a remote computer of a trusted third party for the light pattern identifier, as described in further detail hereinbelow.

In the second example, the light-pattern identifier includes an encrypted version of the light pattern (say a version that is generated in advance of any use of the light pattern, on a computing device of a designer of the light pattern, using an encryption formula).

In the second example, the light pattern identifier is provided to the server computer of the trusted third party in advance of any provisioning of the identifier by the server computer, as described in further detail hereinbelow.

Further in the second example, after receiving the light pattern identifier from the server computer in response to the sending party's querying, before the light pattern is projected onto the area captured in the video or during the light pattern's projection onto the area, the light pattern is generated using a decryption formula. The decryption formula is used to extract the light pattern from the light pattern identifier, as described in further detail hereinbelow.

In the second example, the sending party captures the video with a video camera, and uses the sending party's computing device and the decryption formula, to generate the pattern during the projecting of the light pattern onto the area captured in the video, as described in further detail hereinbelow.

Then, the sending party sends the video to one or more receiving parties.

That is to say that the light pattern identifier determines which light pattern is selected, projected onto the area, and captured in the video.

In the second example, upon receipt 110 of the video by the receiving party, the receiving party too queries the remote computer, for obtaining the light pattern identifier from the server computer, using the time point associated with the video.

Then, the receiving party extracts 120 the light pattern from the received 110 video, extracts a light pattern identifier from the extracted 120 light pattern, and compares 130 the light pattern identifier extracted from the extracted 120 light pattern with the light pattern identifier obtained from the server computer (i.e. with the reference light pattern of the example).

If the receiving party finds the two light pattern identifiers to be identical, the receiving party determines 130 that the video is authentic. Otherwise, the receiving party determines 130 the received video is not authentic.

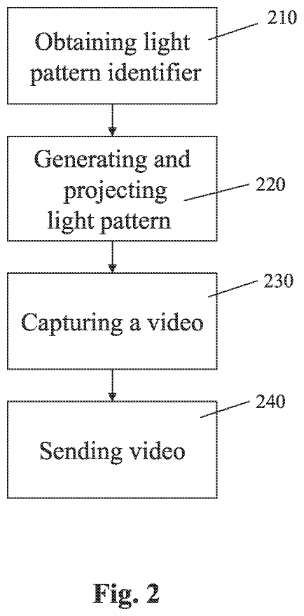

Reference is now made to FIG. 2, which is a flowchart schematically illustrating a second method of authenticating video, according to an exemplary embodiment of the present invention.

A second exemplary method of authenticating video, according to an exemplary embodiment of the present invention, may be executed by a computing device of a sending party that captures and sends a video (say a live video) to one or more receiving parties, as described in further detail hereinbelow.

The computing device may be a single computer (say a tablet computer, a smart cellular phone, a laptop computer, etc.), a group of computers in communication over a network, a computer circuitry that includes one or more electric circuits, a computer processor and a computer memory, etc., or any combination thereof, as described in further detail hereinbelow.

Thus, in one example, the second method is executed by a system 5000 that includes a circuit (say an integrated electric circuit (IC)).

The circuit of the example includes one or more computer processors, one or more computer memories (say a DRAM (Dynamic Random Access Memory) component, an SRAM (Static Random Access Memory) component, an SSD (Solid State Drive) component, etc.), one or more other components, etc., or any combination thereof, as described in further detail hereinbelow.

The computer memory stores instructions, say instructions that are executable by one or more of the system's 5000 computer processor(s), for performing the steps of the second method of video authentication, as described in further detail hereinbelow.

In the second exemplary method, there is obtained 210 a reference light pattern identifier that identifies a light pattern, say by the identifier obtainer 511 of system 5000, as described in further detail hereinbelow.

Optionally, the identifier identifies the light pattern by pointing to the light pattern (i.e. by indexing), or rather, by encrypting the light pattern, as described in further detail hereinbelow.

Optionally, the reference light pattern identifier is obtained 210, by querying a server computer of a third part that is trusted by both the receiving party and the sending party, for the reference light pattern identifier, using querying data, say using data that indicates a time point, as described in further detail hereinbelow.

Upon receiving the querying data, the server computer selects and/or generates the reference light pattern identifier, and provides (say sends) the reference light pattern identifier to the sending party.

Optionally, the server computer selects and/or generates the reference light pattern identifier according to a time point indicated in the querying data, such that the identifier would be the same for all parties who query the server computer with querying data that indicates a same time point.

Optionally, the reference light pattern identifier is rather obtained 210 from an identifier selector used locally by the sending party. The identifier selector selects and/or generates the light pattern identifier, and is one of one or more identifier selector(s), each of which selector(s) is used locally by a respective one the parties.

Optionally, the identifier selector is implemented as an application provided by a third party (say vendor) that is trusted by both the sending party and the receiving party, as a dedicated computing device provided to the parties by the trusted party, etc., as described in further detail hereinbelow.

In one example, the application is installed on a computing device (say a laptop computer, cellular phone, etc.) in general use by the party, whereas in another example, the application is rather installed on a dedicated computing device (say a dongle, a tablet computer, etc.) provided to the party by the trusted third party, as described in further detail hereinbelow.

Optionally, the trusted third party provides the application and/or the dedicated computing device that implements the light pattern identifier selector, in advance of video communication between the parties. The light pattern identifier selector is programmed by the trusted party (say by the vendor's computer programmers), to generate and/or select the identifier per a request, when the request is input to the identifier selector by one of the parties.

Optionally, the identifier selector is a time based identifier selector.

In one example, the time base identifier selector selects and/or generates the light pattern identifier according to data that pertains to a time point (say a time point indicated in a timestamp embedded in the video), which data is input to the identifier selector, say by the identifier obtainer 511, as described in further detail hereinbelow.

In the example, the light pattern identifier that is generated or selected by the identifier selector would be identical to any light pattern identifier generated or selected by any one of the remaining identifier selectors, if the data that is input to the identifier selector indicates a same time point, as described in further detail hereinbelow.

In another example, the identifier selector selects or generates the light pattern identifier based on a time of use of the identifier selector (i.e. based on the time point (say day, hour and minute)) that a request for the identifier is input to the identifier selector at, say by the identifier obtainer 511, as described in further detail hereinbelow.

In the other example, the selected/generated identifier would be the same for each party who possesses one of the identifier selector(s), when the identifier selector is used at a point of time that is within a same time frame (say a time frame defined by a programmer of the identifier selector), as described in further detail hereinbelow.

Optionally, the generation and/or selection of the reference light pattern identifier is/are rather based on a formula or method that the sending party and the receiving party agree upon in advance of video communication between the two or more parties.

The formula or method is known only to the parties or rather, to both the parties and one or more other parties trusted by the sending parties (say other potential recipients the video), and is implemented by a computer application that runs locally on each respective party's computing device, or rather, on a computer that is accessible to both parties, as described in further detail hereinbelow.

Next, there is generated 220 and projected 220 a light pattern, say by the light pattern generator 512 of system 5000, as described in further detail hereinbelow. The light pattern is generated 220 based on the obtained 210 reference light pattern identifier, and is projected 220 onto an area covered by a camera (say a video surveillance camera), using a light source in communication with the sending party's computing device, as described in further detail hereinbelow.

Optionally, the light pattern is generated 220 and projected 220, using a light source (say a projector, a computer screen, etc., or any combination thereof), as described in further detail hereinbelow.

Then, the area that the generated 220 light pattern is projected 220 on, is captured 230 in a video, say by the video capturer 513 that uses the camera for capturing 230 the video, during the projection 220 of the light pattern onto the area, as described in further detail hereinbelow.

Optionally, the video is captured 230 is a live video that is sent (say broadcast live) to one or more receiving parties, say a video of a speech of the US president, that is broadcast live (say on a TV news channel such as CNN™), as described in further detail hereinabove.

Usually, the area is captured 230 in the video together with one or more other objects present in a scene captured 230 in the video, say with a person (say the president), a chair, a TV screen, a curtain, etc., as described in further detail hereinbelow.

The camera may include, but is not limited: a video camera, a stills camera (used to capture a series of still images, to be presented in the video), an omni-directional camera, a 3D camera, a webcam, a camera embedded in the computing device used to implement system 5000, a camera in communication with system 5000, etc., or any combination thereof, as described in further detail hereinbelow.

The area that the light pattern is projected 220 onto and that is captured 230 in the video, may include, but is not limited to: a wall, a curtain, a surveillance area (say a warehouse), a stand, a computer screen, a TV screen, etc., or any combination thereof, as described in further detail hereinabove.

Optionally, the projected 220 light pattern is dynamic. For example, the projected 220 light pattern's color, shape or both the pattern's color and the pattern's shape, may change between at least two frames of the captured 220 video, as described in further detail hereinbelow. Alternatively, the light pattern is rather a static pattern that looks the same through all the captured 230 video's frames that the light pattern appears in.

Then, the captured 230 video is sent 240 to a receiving party, say using the video sender 540 of system 5000, as described in further detail hereinbelow.

In one example, the video is a live video that is broadcast 240 live to one or more receiving parties, say a video of a live press conference, broadcast 240 live on a TV news channel such as CNN™, on a website, on a streaming service, etc., or any combination thereof.

In a second example, the video is a live video sent 240 to one or more specific receiving parties, say a video of a first party to a ZOOM™ meeting, sent 240 live to a second, third and fourth party to the meeting (thus, receiving parties), by a computing device of the first party (thus a sending party).

Optionally, the video is sent 240 together with data that identifies a time point associated with the sent 240 video, say with data that indicates a time point (say day, hour, minute and second) that marks the time (say start or end) of the video's filming by the sending party (say by the video capturer 513).

Optionally, the data that identifies the time point is indicated in a timestamp embedded in the sent 240 video, as described in further detail hereinbelow.

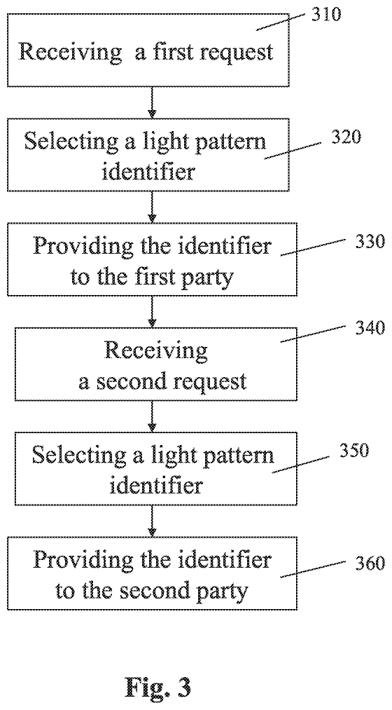

Reference is now made to FIG. 3, which is a flowchart schematically illustrating a third method of authenticating video, according to an exemplary embodiment of the present invention.

A third exemplary method of authenticating video, according to an exemplary embodiment of the present invention, may be executed by a computing device.

Optionally, the computing device is a server computer of a third party trusted by both a sending party and a receiving party, say by a sender and a receiver of a video, as described in further detail hereinbelow.

Optionally, the trusted third party provides a service of generating and/or selecting of light pattern identifiers for different parties or another third party that is an entity trusted by both the sending party and the receiving party, as described in further detail hereinbelow.

Optionally, the computing device is a computing device used by the receiving party or rather, by the sending party, say a computing device provided to the party by a trusted third party (say a vendor), as described in further detail hereinbelow.

The computing device may be a single computer, a group of computers in communication over a network, a computer circuitry that includes one or more electric circuits, a computer processor and a computer memory, etc., or any combination thereof, as described in further detail hereinbelow.

Thus, in one example, the third method is executed by a system 6000 that includes a circuit (say an integrated electric circuit (IC)), as described in further detail hereinbelow.

The circuit of the example includes one or more computer processors, one or more computer memories (say a DRAM (Dynamic Random Access Memory) component, an SRAM (Static Random Access Memory) component, an SSD (Solid State Drive) component, etc.), one or more other components, etc., or any combination thereof, as described in further detail hereinbelow.

The computer memory stores instructions, say instructions that are executable by one or more of the system's 6000 computer processor(s), for performing the steps of the third exemplary method of video authentication, as described in further detail hereinbelow.

In the third exemplary method, there is received 310 a first request for a light pattern identifier that identifies a light pattern, from a computing device of a first party, say of the sending party, as described in further detail and illustrated using FIG. 2 hereinabove.

Optionally, the first request is received 310 by the request receiver 611 of system 6000, as described in further detail hereinbelow.

Optionally, the light pattern identifier identifies the light pattern by pointing to the light pattern (i.e. by indexing), or rather, by encrypting the light pattern, as described in further detail hereinabove.

Optionally, the first request received 310 from the first party's computing device includes querying data, say data that indicates a time point, say an intended time of sending (say broadcasting) of a video (say a video of a live press conference sent in real time to one or more recipients), as described in further detail hereinbelow.

Next, a first light pattern identifier is selected 320 for the first party, say according to the time point indicated in the querying data received 310 from the first party's computing device, say by the identifier determiner 612 of system 6000, as described in further detail hereinbelow.

In one example, the light pattern identifier is selected 320 amongst a number of identifiers stored on the server computer, each one of which identifiers identifies a respective, specific light pattern.

Optionally, the selected 320 light pattern identifier of the example points to one of two or more records of a database, each one of which records points to a graphical file that illustrates a respective light pattern. The database is provided in advance to both the sending party and the receiving party, as described in further detail hereinabove.

Next, the selected 320 first light pattern identifier is provided (say sent) 330 to the first party's (say sending party's) computing device, say by the identifier sender 613 of system 6000, as described in further detail hereinbelow.

Optionally, the reference light pattern identifier is selected 320 according to a time point indicated in the querying data received 310 from the first party's computing device, as described in further detail hereinbelow.

The first party uses the provided 330 light pattern identifier, for generating and projecting the light pattern onto an area during the area's capturing in a video, and sends the video to one or more second parties, as described in further detail hereinabove.

Next in the third method, there is received 340 a second request for a light pattern identifier (i.e. a reference light pattern identifier) that identifies a light pattern, from a computing device of a second party that is in receipt of the video that the light pattern and area are captured in, as described in further detail and illustrated using FIG. 1 hereinabove.

Optionally, the second request is received 340 by the request receiver 611 of system 6000, as described in further detail hereinbelow.

Optionally, the request received 340 from the second party's computing device includes querying data, say data that indicates a time point, say a time point found by the second party's computing device in a timestamp embedded in the video, as described in further detail hereinabove.

Next, a second light pattern identifier is selected 350 for the second party, say according to the time point indicated in the querying data received 340 from the second party's computing device, say by the identifier determiner 612 of system 6000, as described in further detail hereinbelow.

If the video received by the second party (i.e. receiving party) is indeed, the same video as sent by the first party (i.e. sending party), the querying data received 340 from the second party points to the same light pattern identifier as the one selected 320 for the first party, based on the querying data received 310 from the first party. As a result, the same light pattern is selected 320, 350 for the two parties.

In one example, the selected identifier would be the same for each party, when the querying data received from the party, indicates a respective point of time that is within a same time frame (say a time frame defined by a programmer of the server computer), as described in further detail hereinbelow.

Thus, in a specific case of the example, the querying data received 310 from the first party indicates a 12:03:04 time point that is the video's start time of capturing by the first party's computing device. In the specific case, the querying data received 340 from the second party indicates a 12:03:49 time point that is the video's time of receipt by the second party. Both points are indicated in the hh:mm:ss time format, as known in the art.

In the specific case, the server computer is programmed to select the same identifier for any time point that is within a same five minutes long time period, for example, between 12:00:01 to 12:05:00 of a same specific day. Accordingly, the same light pattern identifier is selected 320, 350 for both parties.

Next, the selected 350 pattern is provided (say sent) 360 to the second party's (say receiving party's) computing device, say by the identifier sender 613 of system 6000, as described in further detail hereinbelow.

The second party's (i.e. receiving party's) computing device extracts the light pattern from the video that the second party's computing device receives from the first party and extracts a light pattern identifier from the extracted light pattern.

Then, the second party's computing device verifies authenticity of the received video, by comparing the extracted light pattern identifier with the light pattern identifier provided 350 by the remote computer (i.e. with the reference light pattern of the example), as described in further detail hereinabove.

In the specific case, the light pattern identifier selected 320 based on the video's start time of capturing (12:03:04) and provided 330 to the first party, and the light pattern identifier selected 350 based on the time of receipt of the video by the second party (12:03:49) and provided 360 to the second party, are the same. As a result, the light pattern identifier that is extracted from the light pattern extracted from the received video and the light pattern identifier that the second party receives from the server computer are also the same. Accordingly, the second party's computing device, finds the video to be authentic.

Optionally, the second party further uses a time difference between a time of receipt of the video and the time point indicated in the received, for verifying that the received video is indeed, authentic, as described in further detail hereinabove.

In a second specific case, the video's start time of capturing (say a 12:03:04 time point) is also indicated in a timestamp embedded in the video received by the second party, and is included in the querying data sent to the server computer.

However, in the second case, the video is intercepted, manipulated by a malicious party, forwarded to the second party, and received by the second party at 12:04:48.

As a result, the light pattern identifier provided 360 to the second party is based on the 12:03:04 time point (the video's start time of capturing), and is the same as the light pattern identifier extracted from the light pattern extracted from the received video.

In fact, assuming the computer server remains programmed to change the light pattern identifier every five minutes, as described in further detail hereinabove, the light pattern identifier provided 360 to the second party, would be the same as the identifier extracted from the light pattern extracted from the video, even is selected based on the 12:04:48 time of the video's receipt.

However, in the second case, the authentication of the video is further based on a one minute limit imposed on the time difference between the video's start time of capturing and the video's time of receipt by the second party.

Since the time difference between the video's start time of capturing (12:03:04) and the time of receipt of the video by the second party (12:04:48) exceeds the one minute limit, the second party's computing device finds the video not to be authentic. Thus, the video is not found to be authentic, in spite of the fact that the extracted light pattern identifier and the light pattern obtained from the server computer are the same.

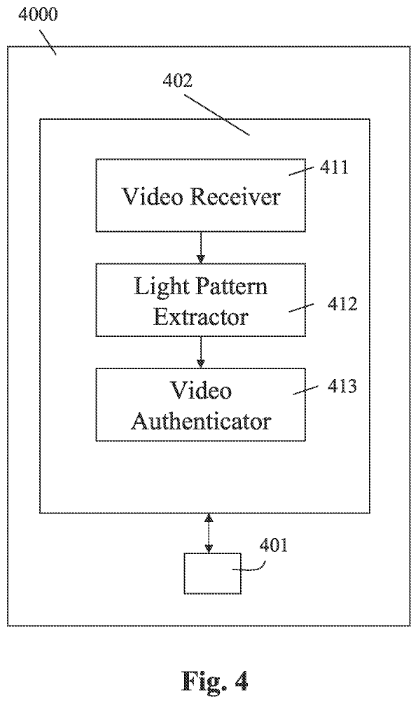

Reference is now made to FIG. 4, which is a simplified block diagram schematically illustrating a first exemplary system for authenticating video, according to an exemplary embodiment of the present invention.

A system 4000 for authenticating video, according to an exemplary embodiment of the present invention, may be implemented using electric circuits, computer software, computer hardware, etc., or any combination thereof.

Optionally, the system 4000 is implemented on a receiving party's computing device.

The computing device may be a single computer (say an internet-connected streaming device, a smart TV set, a smart cellular phone, a laptop or other computer, etc.), a group of computers in communication over a network, a computing circuitry that includes one or more electric circuits, a computer processor, a computer memory, etc., or any combination thereof, as described in further detail hereinbelow.

Optionally, the system 4000 includes one or more electric circuits, say a circuit that includes one or more computer processor(s) 401 and at least one computer memory 402, say one or more circuits of a computer or circuits of two or more computers.

The computer memory 402 may include, but is not limited to: a Micro SD (Secure Digital) Card, a CD-ROM, a USB-Memory, a Hard Disk Drive (HDD), a Solid State Drive (SSD), a computer's ROM chip, an SRAM (Static Random Access Memory), a DRAM (Dynamic Random Access Memory) or other RAM (Random Access Memory) component, a cache memory component of a computer processor, etc., or any combination thereof, as known in the art.

The at least one computer memory 402 stores instructions that are executable by the at least one computer processor 401, other parts of the circuitry, or both, for causing the system 4000 to perform the steps of the first exemplary method described in further detail and illustrated using FIG. 1 hereinbelow.

In one exemplary embodiment, the computer processor 401 is programmed to perform the instructions, and thereby implement one or more additional parts (say modules) of the system 4000, say parts 411-413 shown in FIG. 4.

Optionally, one or more of the parts 411-413 is rather implemented as one or more electric circuits (say a logic circuit), or rather as a combination of one or more electric circuits and the computer processor 401.

Each one of parts 411-413 may thus be implemented as software—say by programming the computer processor(s) 401 to execute at least a part of the first exemplary method described in further detail hereinbelow, as hardware—say as one or more hardware part of the electric circuit(s) that execute(s) at least a part of the first exemplary method, etc., or any combination thereof.

The system 4000 includes a video receiver 411.

The video receiver 411 is configured, say by execution of one or more of the instructions stored on the computer memory 402, to receive a video that shows a light pattern projected onto an area captured in the video (usually, together with one or more other objects, say a person, a car, a door, an audience, etc.), say onto a wall, a curtain, a surveillance area (say a parking lot), a stand, a computer screen, a TV screen, etc., as described in further detail hereinabove.

In one example, the received video is a video of the US President when the president gives a live speech on television (TV).

In the example, the received video shows the light pattern projected onto a physical area that is in the background or foreground of the president, onto an area of an object that stands beside the president, etc.

The physical area of the example may be, for example, a frontal face of a podium used by the president during the speech, a wall or curtain that the president stands before during the speech, a board positioned beside the president during the speech, a computer screen that displays the pattern during the speech, etc.

Optionally, the light pattern is generated based on a reference light pattern identifier, say based on a light pattern identifier obtained from a computer server of a third party trusted by both the sending party and the receiving party, as described in further detail hereinbelow.

The video received by the video receiver 411, is associated with a time point. The time point may be, for example, a time point (say day, hour, minute and second) that marks the time (say start or end) of the video's filming by the sending party, and that is indicated in a timestamp embedded in the video, as described in further detail hereinabove.

Thus, optionally, the time point is indicated in data provided to the receiving party by a trusted third party, say by a third party's computer that records the time of filming of the video, as confirmed to the third party after the third party authenticates the sending party's identity.

The time point may also be, for example, the received video's known time of live broadcast, the point in time at which that the video is received by the video receiver 411, etc., as described in further detail hereinbelow.

The time point may also be, for example, a time point received from a source of the received video (say the video's sending party) or from another source trusted by the receiving party (say a third party trusted by both the receiving party and the sending party), etc., as described in further detail hereinbelow.

The system 4000 further includes a light pattern extractor 412, in communication with the video receiver 411, as described in further detail hereinbelow.

The light pattern extractor 412 is configured, say by execution of one or more of the instructions stored on the computer memory 402, to extract the light pattern from the video received by the video receiver 411, as described in further detail hereinbelow.

Optionally, the light pattern extractor 412 is further configured to extract the light pattern from the received video, using one or more methods of image processing, as described in further detail hereinabove.

The image processing methods may include, but are not limited to object detection and recognition methods, object flow evaluation methods, AI (Artificial Intelligence) based feature mapping methods, AI based segmentation methods, object cropping methods, etc., as known in the art.

For example, the light pattern extractor 412 may be configured to extract the light pattern using one or more of the many tools nowadays available commercially from vendors such as Google™, Amazon™, Microsoft™, and other vendors.

Optionally, the light pattern extractor 412 is further configured to extract the light pattern into one or more video frames that show(s) only the light pattern, say in video frames in which all frame pixels but the pixels occupied by the light pattern are darkened.

Optionally, the light pattern extractor 412 is further configured to extract the light pattern into a motional graphical file or into a file of another graphical or non-graphical format, as described in further detail hereinabove.

Optionally, the light pattern extractor 412 is further configured to extract the light pattern into a file of an agreed-upon standard (say a graphical file of a specific type and/or structure)—say a standard agreed upon between the sending party and the receiving party, a specific industry standard, etc., as known in the art.

The system 4000 further includes a video authenticator 413, in communication with the light pattern extractor 412, as described in further detail hereinbelow.

The video authenticator 413 is configured, say by execution of one or more of the instructions stored on the computer memory 402, to verify authenticity of the received video, based on the extracted light pattern and a reference light pattern identifier, as described in further detail hereinbelow.

Optionally, the video authenticator 413 is further configured to verify the received video's authenticity, by extracting a light pattern identifier from the light pattern that the light pattern extractor 412 extracts from the received video, and comparing the extracted light pattern identifier with a reference light pattern identifier.

Thus, unless the identifier extracted from the extracted light pattern and the reference light pattern identifier are the same, the video authenticator 413 does not find the received video is to be authentic.

Optionally, the video authenticator 413 is further configured to select a second light pattern from a database of light patterns (say a database that is accessible on the trusted party's server computer) and/or generate the second light pattern based on the reference light pattern, and compare the second light pattern to the light pattern extracted from the received video, for verifying authenticity of the received video.

Thus, unless the light pattern that the light pattern extractor 412 extracts from the video and the light pattern that the video authenticator 413 selects and/or generates based on the reference light pattern identifier are the same, the video authenticator 413 does not find the received video to be authentic.

Optionally, the video authenticator 413 is further configured to use a computer application that uses one or more image processing methods, for comparing the light patterns, as described in further detail hereinabove. The computer application is provided to the receiving party by the trusted third party, in advance of the receipt of the video by the video receiver 411, as described in further detail hereinbelow.

Optionally, each one of the light pattern identifier and the reference light pattern identifier is a key or index that identifies the light pattern, as described in further detail hereinbelow.

Optionally, each one of the light pattern identifier and the reference light pattern identifier is a file that the light pattern is encoded in, a text (say character string) that the light pattern in encrypted in, etc., as described in further detail hereinbelow.

In a first example, the video authenticator 413 is further configured to obtain the reference light pattern identifier, by querying a server computer of a third part that is trusted by both the receiving party and the sending party, for the reference light pattern identifier, as described in further detail hereinbelow.

Earlier, at the sending party's end, the light pattern is generated (say by the sending party's computing device) based on the reference light pattern identifier, captured in the video, and sent by the sending party's computing device to the receiving party's computing device, say by system 5000, as described in further detail hereinbelow.

In the first example, the sending party too, obtains the reference light pattern identifier, by querying the trusted third party's server computer, before generating the light pattern based on the reference light pattern, and projecting the light pattern onto the area captured in the video, as described in further detail hereinbelow.

In the first example, the server computer selects and/or generates the reference light pattern identifier, upon receiving a query from one of the parties, and provides the identifier to the party that the query is sent by.

Optionally, the server computer selects and/or generates the light pattern identifier according to a time point indicated in data that the server computer receives from the party as a part of the querying, such that the identifier would be the same for all parties who query the server computer with a same time point, as described in further detail hereinbelow.

In a second example, the video authenticator 413 is further configured to obtain the reference light pattern identifier, using a light pattern selector that selects and/or generates the light pattern. In the example, each one of the parties obtains the reference light pattern, using one or more light pattern identifier selector(s), each of which selector(s) is used locally by a respective one the parties.

Optionally, the light pattern identifier selector is implemented as an application provided by a third party (say vendor) that is trusted by both the sending party and the receiving party, as a dedicated computing device provided by the trusted third party to the parties, etc., as described in further detail hereinbelow.

Thus, in one example, the application that implements the light pattern identifier selector, is installed on a computing device (say a laptop computer, cellular phone, etc.) in general use by the party.

In another example, the application that implements the light pattern selector is rather installed on a dedicated computing device (say a dongle, a tablet computer, etc.) provided to the party by the trusted third party, as described in further detail hereinbelow.

Optionally, the trusted third party (say a vendor trusted by each one of the parties that the video is communicated between) provides the application and/or the dedicated computing device, that implement the light pattern identifier selector, in advance of video communication between the parties. The light pattern identifier selector is programmed by the trusted party (say by the vendor's computer programmers), to generate and/or select the identifier per a request, when the request is input to the identifier selector by one of the parties.

Optionally, the identifier selector is a time based identifier selector.

In one example, the time base identifier selector selects and/or generates the light pattern identifier according to data that pertains to a time point (say to a time point indicated in a timestamp embedded in the video, as described in further detail hereinabove), which data is input to the identifier selector.

In the example, the identifier would be the same for each party in possession of the identifier selector when input data (i.e. data make up at least a part of the request) that indicates the same time point, as described in further detail hereinbelow.

In another example, the identifier selector selects and/or generates the light pattern identifier based on a time of use of the identifier selector (i.e. based on the time point (say day, hour and minute)) that a request to provide the identifier is input to the identifier selector at, as described in further detail hereinbelow.

In the other example, the selected/generated identifier would be the same for each party in possession of one of the identifier selector(s), when the identifier selector is used at a point of time that is within a same time frame, as defined by a programmer of the identifier selector, as described in further detail hereinbelow.

Optionally, the generation and/or selection of the reference light pattern identifier is/are rather based on a formula or method that the sending party and the receiving party agree upon in advance of video communication between the two or more parties.

The formula or method is known only to the parties or rather, to both the parties and one or more other parties trusted by the sending parties (say other potential recipients the video), and is implemented by a computer application that runs locally on each respective party's computing device, or rather, on a computer that is accessible to both parties, as described in further detail hereinbelow.

Optionally, the video authenticator 413 is further configured to use a time difference between a time of receipt of the video by the video receiver 411 and the time point (say the time point indicated in the timestamp embedded in the received video or rather the video's known time of broadcast) is within a predefined limit, for verifying that the received video is authentic.

Optionally, the limit is predefined in advance of the video's communication between the sending party and the receiving party, say by a user, operator or programmer of system 4000.

Thus, in one example, the user, operator or programmer sets the limit (say a one minute limit) based on an estimated minimal duration of time that a malicious party would need, in order to replace the video, before the video is received by the video receiver 411, with a faked video that shows similar background and/or objects as the originally sent video, as described in further detail hereinbelow.

In the example, if the time difference between a time of receipt of the video by the video receiver 411 and the time point (say the time point indicated in the timestamp that) exceeds the time limit (say one minute), the video authenticator 413 determines that the received video is faked rather than authentic.

Optionally, the light pattern identifier is based on an encryption function applied on the light pattern after the pattern is designed by an artist, or other designer, and stored in a database that may be provided or made accessible to the sending party, the receiving party, or both (say on a database stored on the trusted third party's server computer), as described in further detail hereinbelow.

Optionally, the light pattern identifier is based on a random or a non-random key that the designer associates with the light pattern, etc., or any combination thereof, as described in further detail hereinbelow.

In one example, the sending party captures a live video, say of a speech given by a politician, and sends the live video to the receiving party (say to a TV station that intends to broadcast the live video to a large audience). In the example, the light pattern is projected onto an area captured in the live video (say onto a podium used by the politician when captured in the video).

In the example, at the sending party's end, the light pattern is selected from a set of light patterns (say from a database of motional graphical files or of other graphical files, as known in the art), based on a light-pattern identifier, say using system 5000, as described in further detail hereinbelow.

In the example, the light-pattern identifier itself is obtained from a remote server or rather, from an identifier selector operated locally by the sending party, etc., based on data that indicates a time point associated with the video, as described in further detail hereinabove.

In one example, one light-pattern identifier is a key (say ‘A0001’) that identifies a first light pattern of the set (say a first one of the files), whereas a second light-pattern identifier is a key (say ‘A0002’) that identifies a second one of the set's light patterns. Thus, in the example, the light pattern identifier is an index that uniquely identifies a specific light pattern (say by identifying a specific one of the motional graphical files).

In the example, the sending party who captures the video, holds a copy of the set of light patterns (say of the database of the motional graphical files) or rather, is allowed to access the set of light patterns on a remote computer (say the remote computer of the trusted third party, or of a light pattern designer, etc.).

In the example, the sending party's system 5000 selects the light pattern from the set (say by retrieving the file that holds the light pattern from the database), based on the light pattern identifier.

Then the sending party's system 5000 uses one or more light source(s) that is/are in communication with the system 5000, to project the selected light pattern onto the area when captured by the party using a video camera, as described in further detail hereinbelow.

In a second example, the sending party's system 5000 rather queries a remote computer of a trusted third party for the light pattern identifier, as described in further detail hereinbelow.

Then, the sending party's system 5000 sends the video to one or more receiving party.

That is to say that the light pattern identifier determines which light pattern is selected, projected onto the area, and captured in the video.

In the second example, the video receiver 411 receives the video and the light pattern extractor 412 extracts the light pattern from the received video, as described in further detail hereinabove.

Then, in the second example, the video authenticator 413 queries the trusted third party's remote server computer, for obtaining the reference light pattern identifier, using the time point associated with the video, and extracts 120 a light pattern identifier from the extracted light pattern.

Finally, in the second example, the video authenticator 413 compares the light pattern identifier extracted from the light pattern with the light pattern identifier obtained from the trusted third party's server computer (i.e. with the reference light pattern identifier of the example).

In the second example, if the video authenticator 413 finds the two light pattern identifiers to be identical, the video authenticator 413 determines that the video is authentic. Otherwise, the video authenticator 413 determines that the received video is not authentic.

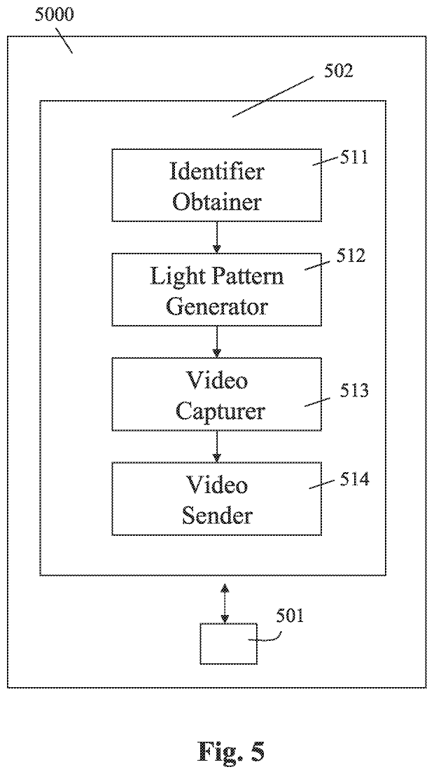

Reference is now made to FIG. 5, which is a simplified block diagram schematically illustrating a second exemplary system for authenticating video, according to an exemplary embodiment of the present invention.

A system 5000 for authenticating video, according to an exemplary embodiment of the present invention, may be implemented using electric circuits, computer software, computer hardware, etc., or any combination thereof.

Optionally, the system 5000 is implemented on a sending party's computing device.

The computing device may be a single computer (say a smart cellular phone, a laptop, desktop or other computer, etc.), a group of computers in communication over a network, a computing circuitry that includes one or more electric circuits, a computer processor, a computer memory, etc., or any combination thereof, as described in further detail hereinbelow.

Optionally, the system 5000 includes one or more electric circuits, say a circuit that includes one or more computer processor(s) 501 and at least one computer memory 502, say one or more circuits of a computer or circuits of two or more computers.

The computer memory 502 may include, but is not limited to: a Micro SD (Secure Digital) Card, a CD-ROM, a USB-Memory, a Hard Disk Drive (HDD), a Solid State Drive (SSD), a computer's ROM chip, an SRAM (Static Random Access Memory), a DRAM (Dynamic Random Access Memory) or other RAM (Random Access Memory) component, a cache memory component of a computer processor, etc., or any combination thereof, as known in the art.

The at least one computer memory 502 stores instructions that are executable by the at least one computer processor 501, other parts of the circuitry, or both, for causing the system 5000 to perform the steps of the second exemplary method described in further detail and illustrated using FIG. 2 hereinbelow.

In one exemplary embodiment, the computer processor 501 is programmed to perform the instructions, and thereby implement one or more additional parts (say modules) of the system 5000, say parts 511-514.

Optionally, one or more of the parts 511-514 is rather implemented as one or more electric circuits (say a logic circuit), or rather as combination of one or more electric circuits and the computer processor 501.

Each one of parts 511-514 may thus be implemented as software—say by programming the computer processor(s) 501 to execute at least a part of the second exemplary method described in further detail hereinbelow, as hardware—say as one or more hardware part of the electric circuit(s) that execute(s) at least a part of the first exemplary method, etc., or any combination thereof.

The system 5000 includes an identifier obtainer 511.

The identifier obtainer 511 is configured, say by execution of one or more of the instructions stored on the computer memory 502, to obtain a reference light pattern identifier that identifies a light pattern, as described in further detail hereinbelow.

Optionally, the identifier identifies the light pattern by pointing to the light pattern (i.e. by indexing), or rather, by encrypting the light pattern, as described in further detail hereinbelow.

Optionally, the identifier obtainer 511 obtains the reference light pattern, by querying a server computer of a third part that is trusted by both the receiving party and the sending party, for the reference light pattern identifier, using querying data, say using data that indicates a time point, as described in further detail hereinbelow.

After receiving the querying data, the server computer selects and/or generates the reference light pattern identifier, and sends the reference light pattern identifier to the identifier obtainer 511.

Optionally, the server computer selects and/or generates the reference light pattern identifier according to a time point indicated in the querying data received from the identifier obtainer 511, such that the identifier would be the same for all parties who query the server computer with querying data that indicates a same time point, as described in further detail hereinabove.

Optionally, the identifier obtainer 511 rather obtains the reference light pattern identifier from an identifier selector used locally by the sending party (i.e. by the identifier obtainer 511). The identifier selector selects and/or generates the light pattern identifier, and is one of one or more identifier selector(s), each of which selector(s) is used locally by a respective one the parties.

Optionally, the identifier selector is implemented as an application provided by a third party (say vendor) that is trusted by both the sending party and the receiving party, as a dedicated computing device that the trusted party provides to the parties, etc., or any combination thereof, as described in further detail hereinbelow.

In one example, the application is installed on a computing device (say a laptop computer, cellular phone, etc.) in general use by the party, whereas in another example, the application is rather installed on a dedicated computing device (say a dongle, a tablet computer, etc.) provided to the party by the trusted third party, as described in further detail hereinbelow.

Optionally, the trusted third party provides the application and/or the dedicated computing device that implement the light pattern identifier selector, in advance of video communication between the parties. The light pattern identifier selector is programmed by the trusted party (say by the vendor's computer programmers), to generate and/or select the identifier per a request, when the request is input to the identifier selector by one of the parties.

Optionally, the identifier selector is a time based identifier selector.

In one example, the time base identifier selector selects and/or generates the light pattern identifier according to data that pertains to a time point (say a time point indicated in a timestamp embedded in the video), which data is input to the identifier selector, say by the identifier obtainer 511, as described in further detail hereinbelow.

In the example, the identifier that is generated or selected by the identifier selector would be the same as any identifier generated or selected by any one of the remaining identifier selectors provided to the parties, if the data that is input to the identifier indicates a same time point, as described in further detail hereinbelow.

In another example, the identifier selector selects or generates the light pattern identifier based on a time of use of the identifier selector (i.e. based on the time point (say day, hour and minute)) that a request for the identifier is input to the identifier selector at, say by the identifier obtainer 511, as described in further detail hereinbelow.

In the other example, the selected/generated identifier would be the same for each party who possesses one of the identifier selector(s), when the identifier selector is used at a point of time that is within a same time frame (say a time frame defined by a programmer of the identifier selector), as described in further detail hereinbelow.

Optionally, the generation and/or selection of the reference light pattern identifier is/are rather based on a formula or method that the sending party and the receiving party agree upon in advance of video communication between the two or more parties.

The formula or method is known only to the parties or rather, to both the parties and one or more other parties trusted by the sending parties (say other potential recipients the video), and is implemented by a computer application that runs locally on each respective party's computing device, or rather, on a computer that is accessible to both parties, as described in further detail hereinabove.

The system 5000 further includes a light pattern generator 512, in communication with the identifier obtainer 511, as described in further detail hereinbelow.

The light pattern generator 512 is configured, say by execution of one or more of the instructions stored on the computer memory 502, to generate and project a light pattern.

The light pattern generator 512 generates the light pattern based on the reference light pattern identifier obtained by the identifier obtainer 511, and projects the light pattern onto an area covered by a camera, using a light source in communication with the light pattern generator 512, as described in further detail hereinbelow.

The light source may include, but is not limited to: a projector, a computer screen, a TV screen, a slide projector, another light source, etc., or any combination thereof, as described in further detail hereinbelow.

The system 5000 further includes a video capturer 513, in communication with the light pattern generator 512, as described in further detail hereinbelow.

The video capturer 513 is configured, say by execution of one or more of the instructions stored on the computer memory 502, to capture the area that the generated light pattern is projected on, in a video, say using the camera, during the projection of the light pattern onto the area.

Optionally, the video captured by the video capturer 513 is a live video that is sent (say broadcast live) to one or more receiving parties, say by the video sender, as described in further detail hereinbelow.

Optionally, the video is of a live speech of the US president, that is broadcast live (say on a TV), as described in further detail hereinabove.

Usually, the video capturer 513 captures the area in the video together with one or more other objects present in a scene captured in the video, say with a person (say the president), a chair, a TV screen, a curtain, etc., as described in further detail hereinbelow.

The camera used by the video capturer 513 for capturing the video, may include, but is not limited to: a video camera, a stills camera used to capture a series of still images, to be presented in the video, an omni-directional camera, a 3D camera, a webcam, a camera embedded in the computing device used to implement system 5000, a camera in communication with system 5000, etc., or any combination thereof, as described in further detail hereinbelow.

The area that the light pattern is projected onto and that is captured in the video (usually, together with one or more other objects, say a person, a car, a door, an audience, etc.), may include, but is not limited to: a wall, a curtain, a surveillance area (say a warehouse), a stand, a computer screen, a TV screen, etc., or any combination thereof, as described in further detail hereinabove.

The system 5000 further includes a video sender 514, in communication with the video capturer 513, as described in further detail hereinbelow.

The video sender 514 is configured, say by execution of one or more of the instructions stored on the computer memory 502, to send the video captured by the video capturer 513, to a receiving party, as described in further detail hereinbelow.

In one example, the video is a live video that the video sender 514 broadcasts to one or more receiving parties, say a video of a live press conference, broadcast live on a TV news channel such as CNN™, on a website, on a cable TV, on a streaming service, etc., or any combination thereof, as described in further detail hereinabove.

In a second example, the video sender 514 sends the video (say the live video) to one or more specific receiving parties.

The video may be, for example, a live video of a first party to a ZOOM™ meeting, Windows Teams™ meting, or other on-line meeting, that the video sender 514 sends live to a second, third and fourth party to the meeting (thus, receiving parties), as known in the art.

Optionally, the video sender 514 sends the video together with data that identifies a time point associated with the sent video, say with data that indicates a time point (say day, hour, minute and second) that marks the time (say start or end) of the video's filming by the video capturer 513.

Optionally, the data that identifies the time point is indicated in a timestamp embedded in the video sent by video sender 514, as described in further detail hereinbelow.

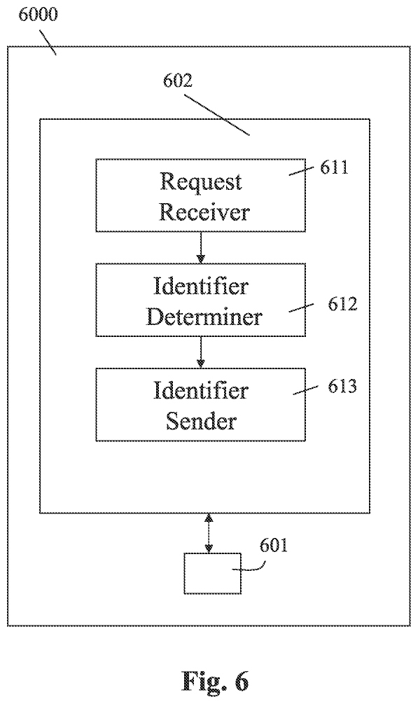

Reference is now made to FIG. 6, which a simplified block diagram schematically illustrating a third exemplary system for authenticating video, according to an exemplary embodiment of the present invention.

A system 6000 for authenticating video, according to an exemplary embodiment of the present invention, may be implemented using electric circuits, computer software, computer hardware, etc., or any combination thereof.

Optionally, the system 6000 is implemented on a computing device, say a computer server of a third party trusted by both a sending party and a receiving party (say by both a sender of a video and one or more recipients of the video), as described in further detail hereinabove.

The computing device may be a single computer, a group of computers in communication over a network, a computing circuitry that includes one or more electric circuits, a computer processor, a computer memory, etc., or any combination thereof, as described in further detail hereinbelow.

Optionally, the system 6000 includes one or more electric circuits, say a circuit that includes one or more computer processor(s) 601 and at least one computer memory 602, say one or more circuits of a computer or circuits of two or more computers.

The computer memory 602 may include, but is not limited to: a Micro SD (Secure Digital) Card, a CD-ROM, a USB-Memory, a Hard Disk Drive (HDD), a Solid State Drive (SSD), a computer's ROM chip, an SRAM (Static Random Access Memory), a DRAM (Dynamic Random Access Memory) or other RAM (Random Access Memory) component, a cache memory component of a computer processor, etc., or any combination thereof, as known in the art.

The at least one computer memory 602 stores instructions that are executable by the at least one computer processor 601, other parts of the circuitry, or both, for causing the system 6000 to perform the steps of the third exemplary method described in further detail and illustrated using FIG. 3 hereinbelow.

In one exemplary embodiment, the computer processor 601 is programmed to perform the instructions, and thereby implement one or more additional parts (say modules) of the system 6000, say parts 611-613.

Optionally, one or more of the parts 611-613 is rather implemented as one or more electric circuits (say a logic circuit), or rather as combination of one or more electric circuits and the computer processor 601.

Each one of parts 611-613 may thus be implemented as software—say by programming the computer processor(s) 601 to execute at least a part of the second exemplary method described in further detail hereinbelow, as hardware—say as one or more hardware part of the electric circuit(s) that execute(s) at least a part of the first exemplary method, etc., or any combination thereof.

Accordingly, the system 6000 includes a request receiver 611.

The request receiver 611 is configured, say by execution of one or more of the instructions stored on the computer memory 602, to receive a first request for a light pattern identifier that identifies a light pattern, from a computing device of a first party, say of the sending party, as described in further detail and illustrated using FIG. 2 hereinabove.

Optionally, the identifier identifies the light pattern by pointing to the light pattern (i.e. by indexing), or rather, by encrypting the light pattern, as described in further detail hereinabove.

Optionally, the first request received from the first party's computing device includes querying data, say data that indicates a time point, say an intended time of sending (say broadcasting) of a video (say a video of a live press conference sent in real time to one or more recipients), as described in further detail hereinabove.

The system 6000 further includes an identifier determiner 612, in communication with the request receiver 611.

The identifier determiner 612 is configured, say by execution of one or more of the instructions stored on the computer memory 602, to select a light pattern identifier for the first party, say according to the time point indicated in the querying data received from the first party's computing device, as described in further detail hereinbelow.

In one example, the identifier determiner 612 selects the light pattern identifier amongst a number of identifiers stored on the server computer. In the example, each one of the identifiers identifies a respective, specific light pattern. Optionally, the specific light pattern is a one of several light patterns that are provided in advance to both the sending party and the receiving party, say in a database of graphical files, as described in further detail hereinabove.

The system 6000 further includes an identifier sender 613, in communication with the identifier determiner 612.

The identifier sender 613 is configured, say by execution of one or more of the instructions stored on the computer memory 602, to provide (say send) the selected first light pattern identifier to the first party's (say sending party's) computing device, as described in further detail hereinbelow.

Optionally, the identifier determiner 612 selects the reference light pattern identifier according to a time point indicated in the querying data that the request receiver 611 receives from the first party's computing device, as described in further detail hereinbelow.

The first party uses the provided light pattern identifier, for generating and projecting the light pattern onto an area during the area's capturing in a video, and sends the video to one or more second parties, as described in further detail hereinabove.

The request receiver 611 is further configured, say by execution of one or more of the instructions stored on the computer memory 602, to receive a second request for a light pattern identifier that identifies a light pattern. The request receiver 611 receives the second request from a computing device of a second party that is in receipt of the video that the light pattern and area are captured in, as described in further detail and illustrated using FIG. 1 hereinabove.

Optionally, the second request includes querying data, say data that indicates a time point, say a time point found by the second party's computing device in a timestamp embedded in the video, as described in further detail hereinbelow.

The identifier determiner 612 is further configured, say by execution of one or more of the instructions stored on the computer memory 602, to select for the second party, a second light pattern, say according to the time point indicated in the querying data received from the second party's computing device, as described in further detail hereinbelow.

If the video received by the second party (i.e. receiving party) is indeed, the same video as sent by the first party (i.e. sending party), the querying data that the request receiver 611 receives from the second party points to the same light pattern identifier as the one selected for the first party, based on the querying data received from the first party. As a result, the identifier determiner 612 selects the same light pattern for the two parties.

In one example, the selected identifier would be the same for each party, when the querying data received from the party, indicates a respective point of time that is within a same time frame (say a time frame defined by a programmer of the server computer), as described in further detail hereinbelow.

Thus, in a specific case of the example, the querying data that the request receiver 611 receives from the first party indicates a 12:03:04 time point that is the video's start time of capturing by the first party's computing device. In the specific case, the querying data that the request receiver 611 receives from the second party's computing device indicates a 12:03:49 time point that is the video's time of receipt by the second party.

In the specific case, the identifier determiner 612 selects the same identifier for any time point that is within a same five minute time period, for example, between 12:00:01 to 12:05:00 of a same day. Accordingly, the identifier determiner 612 selects the same light pattern identifier for both parties.

The identifier sender 613 is further configured, say by execution of one or more of the instructions stored on the computer memory 602, to provide (say send) the identifier selected for the second party, to the second party's (say receiving party's) computing device, as described in further detail hereinbelow.

The second party's (i.e. receiving party's) computing device extracts the light pattern from the video that the second party's computing device receives from the first party and extracts a light pattern identifier from the extracted light pattern.

Then, the second party's computing device verifies authenticity of the received video, by comparing the extracted light pattern identifier with the identifier provided by the identifier sender 613 to the second party, as described in further detail hereinabove.

In the specific case, the light pattern identifier selected based on the video's start time of capturing (12:03:04) and provided to the first party, and the light pattern identifier selected based on the time of receipt of the video by the second party (12:03:49) and provided to the second party, are the same. As a result, the light pattern identifier that is extracted from the light pattern extracted from the received video and the light pattern identifier that the second party receives from the identifier sender 613 are also the same. Accordingly, the second party's computing device, finds the video to be authentic.

Optionally, the second party's computing device further uses a time difference between a time of receipt of the video and a time point associated with the received video (say a time point indicated in the received video's timestamp), for verifying that the received video is indeed, authentic, as described in further detail hereinbelow.

Thus, in a second specific case, the video's start time of capturing (say a 12:03:04 time point) is also indicated in a timestamp embedded in the video received by the second party, and is included in the querying data that the request receiver 611 receives from the second party.

However, in the second case, the video is intercepted and manipulated by a malicious party, forwarded by the malicious party to the second party, and received by the second party at 12:04:48.

As a result, the light pattern identifier provided to the second party is based on the 12:03:04 time point (the video's start time of capturing), and is the same as the light pattern identifier extracted from the light pattern extracted from the received video.

Actually, even when assuming that the identifier determiner 612 is configured (say programmed) to change the light pattern identifier every five minutes, as described in further detail hereinabove, the light pattern identifier provided to the second party, would still be the same as the identifier extracted from the light pattern extracted from the video.

However, in the second case, the authentication of the video is further based on a one minutes limit applied to the time difference between the video's start time of capturing and the video's time of receipt by the second party, as described in further detail hereinabove.

Since the time difference between the video's start time of capturing (12:03:04) and the video's time of receipt by the second party (12:04:48) exceeds the one minute limit, the second party's computing device finds the video not to be authentic. Thus, the video is not found to be authentic, in spite of the fact that the extracted light pattern identifier and the light pattern obtained from the server computer (i.e. received from the identifier sender 613) are the same.

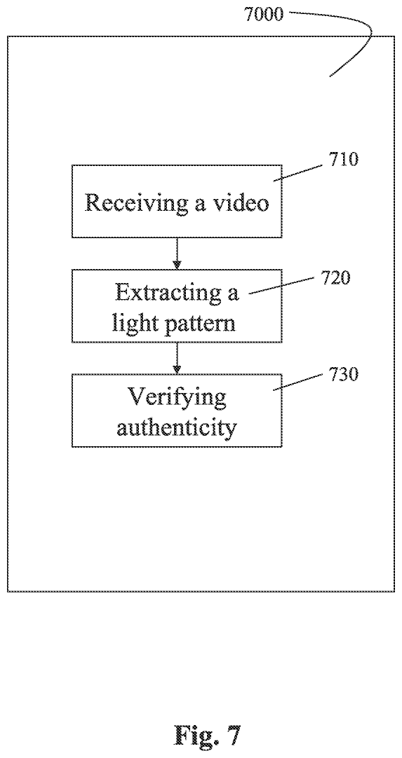

Reference is now made to FIG. 7, which is a simplified block diagram schematically illustrating a first exemplary non-transitory computer readable medium having stored thereon instructions for causing a processing circuitry to perform a process of authenticating video, according to an exemplary embodiment of the present invention.

According to an exemplary embodiment of the present invention, there is provided a non-transitory computer readable medium 7000.

The medium 7000 may include, but is not limited to, a Micro SD (Secure Digital) Card, a CD-ROM, a USB-Memory, a Hard Disk Drive (HDD), a Solid State Drive (SSD), a computer's ROM chip, an SRAM (Static Random Access Memory), a DRAM (Dynamic Random Access Memory) or other RAM (Random Access Memory) component, a cache memory component of a computer processor, etc., or any combination thereof, as known in the art.

Optionally, the computer readable medium 7000 is a part of a system used to implement the exemplary first method illustrated in FIG. 1, say of system 4000 in use by a receiving party, as described in further detail hereinabove.

Optionally, the instructions are computer-executable instructions coded and stored on the medium 7000 by a programmer. The instructions may be executed on one or more computers, say by one or more processors of the receiving party's system 4000, as described in further detail hereinabove.

The instructions include a step of receiving 710 a video that shows a light pattern projected onto an area captured in the received 710 video, say onto a wall, a curtain, a surveillance area (say a parking lot), a stand, a computer screen, a TV screen, etc, as described in further detail hereinabove.

In one example, the received 710 video is a video of the US President when the president gives a live speech on TV. In the example, the received 710 video shows the light pattern projected onto a physical area that is in the background or foreground of the president, as described in further detail hereinabove.

Optionally, the light pattern is generated based on a light pattern identifier, say based on a reference light pattern identifier obtained from a computer server of a third party trusted by both the sending party and the receiving party, as described in further detail hereinabove

The received 710 video is associated with a time point, say a time point that marks the time (say start or end) of the received 710 video's filming by the sending party and that is indicated in a timestamp embedded in the received 110 video, the point in time at which that the video is received 710 by the receiving party, etc., as described in further detail hereinabove.

The instructions further include a step of extracting 720 the light pattern from the received 710 video, say using methods of image processing, such as object flow evaluation methods, AI (Artificial Intelligence) based feature mapping methods, AI based segmentation methods, object cropping methods, etc., described in further detail hereinabove.

For example, the light pattern may be extracted 720 using one or more of the many tools nowadays available commercially from vendors such as Google™, Amazon™, Microsoft™, and other vendors.

Optionally, the light pattern is extracted 720 into one or more video frames that show(s) only the light pattern, say into video frames in which all frame pixels but the pixels occupied by the light pattern are darkened, as described in further detail hereinabove.

Optionally, the light pattern is extracted 720 into a motional graphical file or into a file of another graphical or non-graphical format, as described in further detail hereinabove.

Optionally, the light pattern is extracted 720 into a file of an agreed-upon standard (say a graphical file of a specific type and/or structure), as described in further detail hereinabove.

The instructions further include a step of verifying 730 authenticity of the received 710 video, based on the extracted 720 light pattern and a reference light pattern identifier, as described in further detail hereinabove.

Optionally, the authenticity of the received 710 video is verified 730 by extracting a light pattern identifier from the light pattern extracted 720 from the received 710 video, and comparing the extracted light pattern identifier with a reference light pattern identifier, as described in further detail hereinabove.

Thus, unless the identifier extracted from the extracted 720 light pattern and the reference light pattern identifier are the same, the received 710 video is not found to be authentic.

Optionally, the authenticity of the received 710 video is rather verified 730 by selecting a second light pattern from a database of light patterns (say a database that is accessible on the trusted party's server computer) and/or generating the second light pattern based on the reference light pattern, as described in further detail hereinabove.

Then, the second light pattern is compared with the light pattern extracted 720 from the received 710 video, say using a computer application that uses one or more image processing methods, as described in further detail hereinabove.

The computer application is provided to the receiving party by the trusted third party, in advance of the receipt 710 of the video, as described in further detail hereinabove.

In a first example, the step of verifying 730 includes obtaining the reference light pattern identifier, by querying a server computer of a third part that is trusted by both the receiving party and the sending party, for the reference light pattern identifier, as described in further detail hereinabove.

Earlier, at the sending party's end, the light pattern is generated (say by the sending party's computing device) based on the reference light pattern identifier, captured in the video, and sent by the sending party's computing device to the receiving party's computing device, as described in further detail hereinabove.

In the first example, the sending party too, obtains the reference light pattern identifier, by querying the trusted third party's server computer, before generating the light pattern based on the reference light pattern, and projecting the light pattern onto the area captured in the video, as described in further detail hereinbelow.

In the first example, the server computer selects and/or generates the reference light pattern identifier, upon receiving a query from one of the parties, and provides the identifier to the party that the query is sent by.

Optionally, the server computer selects and/or generates the light pattern identifier according to a time point indicated in data that the server computer receives from the party as a part of the querying, such that the identifier would be the same for all parties who query the server computer with a same time point, as described in further detail hereinabove.

In a second example, the light pattern identifier is rather selected and/or generated by one or more identifier selector(s), each of which selector(s) is used locally by a respective one the parties.

Optionally, the identifier selector is implemented as an application provided by a third party (say vendor) that is trusted by both the sending party and the receiving party, as a dedicated computing device provided by the trusted third party to the parties by the trusted third party, etc., as described in further detail hereinabove.

Thus, in one example, the application is installed on a computing device (say a laptop computer, cellular phone, etc.) in general use by the party, whereas in another example, the application is rather installed on a dedicated computing device (say a dongle, a tablet computer, etc.) provided to the party by the trusted third party, as described in further detail hereinabove.

Optionally, the trusted third party (say a vendor trusted by each one of the parties that the video is communicated between) provides the application and/or the dedicated computing device, that implement the light pattern identifier selector, in advance of video communication between the parties. The light pattern identifier selector is programmed by the trusted party (say by the vendor's computer programmers), to generate and/or select the identifier per a request, when the request is input to the identifier selector by one of the parties, as described in further detail hereinabove.

Optionally, the identifier selector is a time based identifier selector.

In one example, the time base identifier selector selects and/or generates the light pattern identifier according to data that pertains to a time point (say a time point indicated in a timestamp embedded in the video, as known in the art), which data is input to the identifier selector.

In the example, the identifier would be the same for each party in possession of the identifier selector when input data (i.e. data make up at least a part of the request) that indicates the same time point, as described in further detail hereinbelow. In another example, the identifier selector selects and/or generates the light pattern identifier based on a time of use of the identifier selector (i.e. based on the time point (say day, hour and minute)) that a request to provide the identifier is input to the identifier selector at, as described in further detail hereinbelow.

In the other example, the selected/generated identifier would be the same for each party in possession of one of the identifier selector(s), when the identifier selector is used at a point of time that is within a same time frame, as defined by a programmer of the identifier selector, as described in further detail hereinbelow.

Optionally, the generation and/or selection of the reference light pattern identifier is/are rather based on a formula or method that the sending party and the receiving party agree upon in advance of video communication between the two or more parties, as described in further detail hereinabove.

The formula or method is known only to the parties or rather, to both the parties and one or more other parties trusted by the sending parties (say other potential recipients the video), and is implemented by a computer application that runs locally on each respective party's computing device, or rather, on a computer that is accessible to both parties, as described in further detail hereinabove.

Optionally, the step of verifying 730 further includes verifying that a time difference between a time of receipt 710 of the video by the receiving party and the time point is within a predefined limit.

Optionally, the limit is predefined in advance of the video's communication between the sending party and the receiving party (say by a user, operator or programmer of the system that executes the instructions), as described in further detail hereinabove.

Thus, in one example, the user, operator or programmer sets the limit (say a one minute limit) based on an estimated minimal duration of time that a malicious party would need, in order to replace the video, before the video is received 710 by the receiving party, with a faked video that shows similar background and/or objects as the originally sent video, as described in further detail hereinbelow.

In the example, if the time difference between a time of receipt 710 of the video by the receiving party and the time point (say the time point indicated in the timestamp that) exceeds the time limit (say one minute), the received 710 video is found to be faked rather than authentic, as described in further detail hereinabove.

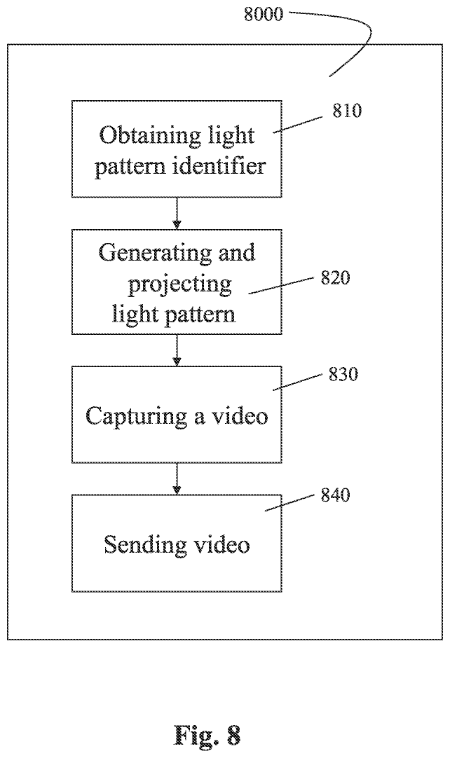

Reference is now made to FIG. 8, which is a simplified block diagram schematically illustrating a second exemplary non-transitory computer readable medium having stored thereon instructions for causing a processing circuitry to perform a process of authenticating video, according to an exemplary embodiment of the present invention.

According to an exemplary embodiment of the present invention, there is provided a non-transitory computer readable medium 8000.

The medium 8000 may include, but is not limited to, a Micro SD (Secure Digital) Card, a CD-ROM, a USB-Memory, a Hard Disk Drive (HDD), a Solid State Drive (SSD), a computer's ROM chip, an SRAM (Static Random Access Memory), a DRAM (Dynamic Random Access Memory) or other RAM (Random Access Memory) component, a cache memory component of a computer processor, etc., or any combination thereof, as known in the art.

Optionally, the computer readable medium 8000 is a part of a system used to implement the exemplary second method illustrated in FIG. 2, say of system 5000 in use by a sending party, as described in further detail hereinabove.

Optionally, the instructions are computer-executable instructions coded and stored on the medium 8000 by a programmer. The instructions may be executed on one or more computers, say by one or more processors of the sending party's system 5000, as described in further detail hereinabove.

The instructions include a step of obtaining 810 a reference light pattern identifier that identifies a light pattern, say by indexing or rather, by encrypting, as described in further detail hereinabove.

Optionally, the reference light pattern identifier is obtained 810, by querying a server computer of a third part that is trusted by both the receiving party and the sending party, for the reference light pattern identifier, using querying data, say using data that indicates a time point, as described in further detail hereinabove.

Optionally, the server computer selects and/or generates the reference light pattern identifier according to a time point indicated in the querying data, such that the identifier would be the same for all parties who query the server computer with querying data that indicates a same time point, as described in further detail hereinabove.

Optionally, the reference light pattern identifier is rather obtained 810 from an identifier selector used locally by the sending party. The identifier selector selects and/or generates the light pattern identifier, and is one of one or more identifier selector(s), each of which selector(s) is used locally by a respective one the parties.

Optionally, the identifier selector is implemented as an application provided by a third party (say vendor) that is trusted by both the sending party and the receiving party, as a dedicated computing device provided by the trusted third party to the parties by the trusted party, etc., as described in further detail hereinabove.

In one example, the application is installed on a computing device (say a laptop computer, cellular phone, etc.) in general use by the party, whereas in another example, the application is rather installed on a dedicated computing device (say a dongle, a tablet computer, etc.) provided to the party by the trusted third party, as described in further detail hereinabove.

Optionally, the trusted third party provides the application and/or the dedicated computing device that implement the light pattern identifier selector, in advance of video communication between the parties. The light pattern identifier selector is programmed by the trusted party (say by the vendor's computer programmers), to generate and/or select the identifier per a request, when the request is input to the identifier selector by one of the parties.

Optionally, the identifier selector is a time based identifier selector.

In one example, the time base identifier selector selects and/or generates the light pattern identifier according to data that pertains to a time point (say a time point indicated in a timestamp embedded in the video), which data is input to the identifier selector, as described in further detail hereinabove.

In the example, the identifier that is generated or selected by the identifier selector, would be the same as any identifier generated or selected by any one of the remaining identifier selectors, if the input data to the identifier selector, indicates a same time point, as described in further detail hereinabove.

In another example, the identifier selector selects or generates the light pattern identifier based on a time of use of the identifier selector (i.e. based on the time point (say day, hour and minute)) that a request for the identifier is input to the identifier selector at, as described in further detail hereinabove.

In the other example, the selected/generated identifier would be the same for each party who possesses one of the identifier selector(s), when the identifier selector is used at a point of time that is within a same time frame (say a time frame defined by a programmer of the identifier selector).

Optionally, the generation and/or selection of the reference light pattern identifier is/are rather based on a formula or method that the sending party and the receiving party agree upon in advance of video communication between the two or more parties, as described in further detail hereinabove.

The formula or method is known only to the parties or rather, to both the parties and one or more other parties trusted by the sending parties (say other potential recipients the video), and is implemented by a computer application that runs locally on each respective party's computing device, or rather, on a computer that is accessible to both parties, as described in further detail hereinabove.

The instructions further include a step of generating 820 and projected 820 a light pattern, as described in further detail hereinabove.

The light pattern is generated 820 based on the obtained 810 reference light pattern identifier, and is projected 820 onto an area covered by a camera (say a video camera), using a light source in communication with the sending party's computing device, as described in further detail hereinabove.

The instructions further include a step of capturing 830 the area that the light pattern is projected 820 onto, in a video, during the projection 820 of the light pattern onto the area.

Optionally, the area and light pattern are captured 830 in a video that is a live video sent (say broadcast live) to one or more receiving parties, say a video speech of the US president, that is broadcast live (say on a TV news channel such as CNN™), as described in further detail hereinabove.

Usually, the area is captured 830 in the video together with one or more other objects present in a scene captured 830 in the video, say with a person, a chair, a TV screen, a curtain, etc., as described in further detail hereinbelow.

The instructions further include a step of sending 840 the captured 830 video to a receiving party, as described in further detail hereinbelow.

In one example, the video is a live video that broadcast 840 live to one or more receiving parties, say a video of a live speech of the US president, broadcast 840 live on a TV news channel, on a website, on cable TV, on a streaming service, etc., or any combination thereof, as described in further detail hereinabove.

In a second example, the video is a live video sent 840 to one or more specific receiving parties, say a video of a first party to a ZOOM™ meeting, sent 840 live to a second party to the meeting (thus a receiving party), by a computing device of the first party (thus a sending party).

Optionally, the video is sent 840 together with data that identifies a time point associated with the sent 840 video, say with data that indicates a time point (say day, hour, minute and second) that marks the time (say start or end) of the video's filming by the sending party, as described in further detail hereinabove.

Optionally, the data that identifies the time point is indicated in a timestamp embedded in the sent 840 video, as described in further detail hereinabove.

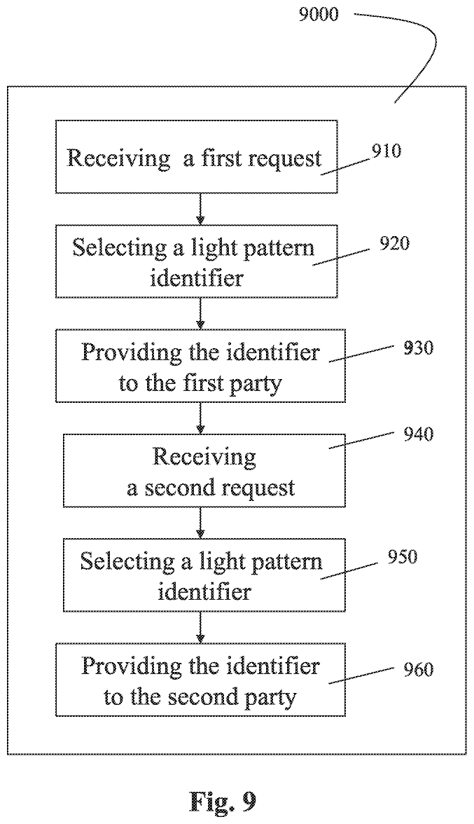

Reference is now made to FIG. 9, which is a simplified block diagram schematically illustrating a third exemplary non-transitory computer readable medium having stored thereon instructions for causing a processing circuitry to perform a process of authenticating video, according to an exemplary embodiment of the present invention.

According to an exemplary embodiment of the present invention, there is provided a non-transitory computer readable medium 9000.

The medium 9000 may include, but is not limited to, a Micro SD (Secure Digital) Card, a CD-ROM, a USB-Memory, a Hard Disk Drive (HDD), a Solid State Drive (SSD), a computer's ROM chip, an SRAM (Static Random Access Memory), a DRAM (Dynamic Random Access Memory) or other RAM (Random Access Memory) component, a cache memory component of a computer processor, etc., or any combination thereof, as known in the art.

Optionally, the computer readable medium 9000 is a part of a system used to implement the exemplary third method illustrated in FIG. 3, say of system 6000 in use by a third party trusted by both a sending party and a receiving party, as described in further detail hereinabove.

Optionally, the instructions are computer-executable instructions coded and stored on the medium 9000 by a programmer. The instructions may be executed on one or more computers (say by one or more processors of the server computer that system 9000 is implemented on, as described in further detail hereinabove).

The instructions include a step of receiving 910 a first request for a light pattern identifier that identifies a light pattern, from a computing device of a first party, say of the sending party, as described in further detail and illustrated using FIG. 2 hereinabove.

Optionally, the identifier identifies the light pattern by pointing to the light pattern (i.e. by indexing), or rather, by encrypting the light pattern, as described in further detail hereinabove.

Optionally, the first request received 910 from the first party's computing device includes querying data, say data that indicates a time point, say an intended time of sending (say broadcasting) of a video (say a video of a live press conference sent in real time to one or more recipients), as described in further detail hereinabove.

The instructions further include a step of selecting 920 a first light pattern identifier for the first party, say according to the time point indicated in the querying data received 910 from the first party's computing device, as described in further detail hereinabove.

In one example, the identifier is selected 920 amongst a number of identifiers stored on the server computer, each one of which identifiers identifies a respective, specific light pattern (say a specific entry in a database of light patterns that is provided in advance to both the sending party and the receiving party, say a database of graphical files, as described in further detail hereinabove).

The instructions further include a step of providing (say sending) 930 the selected 920 light pattern identifier to the first party's (say sending party's) computing device, as described in further detail hereinabove.

Optionally, the reference light pattern identifier is selected 920 according to a time point indicated in the querying data received 910 from the first party's computing device, as described in further detail hereinbelow.

The first party uses the provided 930 light pattern identifier, for generating and projecting the light pattern onto an area during the area's capturing in a video, and sends the video to one or more second parties, as described in further detail hereinabove.

The instructions further include a step of receiving 940 a second request for a light pattern identifier that identifies a light pattern, from a computing device of a second party that is in receipt of the video that the light pattern and area are captured in, as described in further detail and illustrated using FIG. 1 hereinabove.

Optionally, the request received 940 from the second party's computing device includes querying data, say data that indicates a time point, say a time point found by the second party's computing device in a timestamp embedded in the video, as described in further detail hereinabove.

The instructions further include a step of selecting 950 a light pattern identifier for the second party, say according to the time point indicated in the querying data received 940 from the second party's computing device, as described in further detail hereinabove.

If the video received by the second party (i.e. receiving party) is indeed, the same video as sent by the first party (i.e. sending party), the querying data received 940 from the second party points to the same light pattern identifier as selected 920 for the first party. As a result, the same light pattern is selected 920, 950 for the two parties.

In one example, the selected identifier would be the same for each party, when the querying data received from the party, indicates a respective point of time that is within a same time frame (say a time frame defined by a programmer of the server computer), as described in further detail hereinabove.

The instructions further include a step of providing 960 (say sending) the selected 950 light pattern identifier to the second party's (say receiving party's) computing device, as described in further detail hereinabove.

The second party's (i.e. receiving party's) computing device extracts the light pattern from the video that the second party's computing device receives from the first party and extracts a light pattern identifier from the extracted light pattern. Then, the second party's computing device verifies authenticity of the received video, by comparing the extracted light pattern identifier with the identifier provided 350 by the remote computer, as described in further detail hereinabove.

Optionally, the second party further uses a time difference between a time of receipt of the video and the time point indicated in the received, for verifying that the received video is indeed, authentic, as described in further detail hereinabove. It is expected that during the life of this patent many relevant devices and systems will be developed and the scope of the terms herein, particularly of the terms “Computer”, “Camera”, “Computer Screen”, “Video”, “Frame”, “Image”, “CD-ROM”, “USB-Memory”, Dynamic Random Access Memory (DRAM), “Hard Disk Drive (HDD)”, “Solid State Drive (SSD)”, “Processor”, “Circuitry”, component, Static Random Access Memory (SRAM), SSD (Solid State Drive) component, AI Artificial Intelligence (AI), etc., is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of authenticating video, comprising using a computing device of a receiving party, for:
receiving a video showing a light pattern being projected onto an area captured in the video, the video being associated with a time point;
extracting the light pattern from the received video; and
verifying authenticity of the received video based on the extracted light pattern, on a reference light pattern identifier, and on a time difference between a time of receipt of the video by the receiving party and the time point.

2. The method of claim 1, further comprising verifying that the time difference between the time of receipt of the video by the receiving party and the time point is within a predefined limit.

3. The method of claim 1, further comprising obtaining the reference light pattern identifier, by querying a server computer of a trusted third party.

4. The method of claim 1, further comprising obtaining the reference light pattern identifier, by querying a server computer of a trusted third party, using data indicating the time point.

5. The method of claim 1, further comprising obtaining the reference light pattern identifier, using a light pattern identifier selector used locally by the receiving party.

6. The method of claim 1, further comprising obtaining the reference light pattern identifier, using a light pattern identifier selector used locally by the receiving party and data indicating the time point.

7. The method of claim 1, further comprising extracting a light pattern identifier from the extracted light pattern, and verifying that the extracted light pattern identifier is identical to the reference light pattern identifier.

8. The method of claim 1, further selecting a second light pattern from a database of light patterns, using the reference light pattern identifier, and verifying that the selected light pattern is identical to the light pattern extracted from the received video.

9. The method of claim 1, wherein the time point is indicated in a timestamp embedded in the received video.

10. The method of claim 1, wherein the time point is a time of live broadcasting of the video.

11. A system for authenticating video, the system implemented on a computing device of a receiving party and comprising:
a processing circuitry; and
a memory in communication with said processing circuitry, the memory containing instructions that, when executed by the processing circuitry, cause the system to:
receive a video showing a light pattern being projected onto an area captured in the video, the video being associated with a time point;
extract the light pattern from the video; and
verify authenticity of the video based on the extracted light pattern, on a reference light pattern identifier, and on a time difference between a time of receipt of the video by the receiving party and the time point.

12. The system of claim 11, wherein when executed by the processing circuitry, the instructions further cause the system to verify that the time difference between the time of receipt of the video by the receiving party and the time point is within a predefined limit.

13. The system of claim 11, wherein when executed by the processing circuitry, the instructions further cause the system to obtain the reference light pattern identifier, by querying a server computer of a trusted third party.

14. The system of claim 11, wherein when executed by the processing circuitry, the instructions further cause the system to obtain the reference light pattern identifier by querying a server computer of a trusted third party, using data identifying the time point.

15. The system of claim 11, wherein when executed by the processing circuitry, the instructions further cause the system to obtain the reference light pattern identifier, using a light pattern identifier selector used locally by the receiving party.

16. The system of claim 11, wherein when executed by the processing circuitry, the instructions further cause the system to obtain the reference light pattern identifier, using a light pattern identifier selector used locally by the receiving party and data identifying the time point.

17. The system of claim 11, wherein when executed by the processing circuitry, the instructions further cause the system to extract an identifier from the extracted light pattern, and verify that the extracted identifier is identical to the reference light pattern identifier.

18. A non-transitory computer readable medium having stored thereon instructions for causing a processing circuitry of a computing device of a receiving party to perform a process of authenticating video, the process comprising:
receiving a video showing a light pattern being projected onto an area captured in the video, the video being associated with a time point;
extracting the light pattern from the video; and
verifying authenticity of the video based on the extracted light pattern, on a reference light pattern identifier, and on a time difference between a time of receipt of the video by the receiving party and the time point.

19. A method of authenticating video, the method comprising steps performed by a computing device of a sending party, the steps comprising:
obtaining a reference light pattern identifier, the identifier identifying a light pattern;
using a light source in communication with the computing device of the sending party, generating and projecting the light pattern identified by the identifier, onto an area covered by a camera;
using the camera, capturing the area while being projected with the light pattern in a video; and
sending the video to a receiving party.

20. The method of claim 19, further comprising querying a server computer of a trusted third party, for the reference light pattern identifier.

21. The method of claim 19, further comprising querying a server computer of a trusted third party, for the reference light pattern identifier, using data identifying a time point associated with the video.

22. The method of claim 19, further comprising obtaining the reference light pattern identifier, using a light pattern identifier selector used locally by the sending party.

23. The method of claim 19, further comprising obtaining the reference light pattern identifier, using a light pattern identifier selector used locally by the sending party and data identifying a time point associated with the video.

24. The method of claim 19, further comprising sending the video with data identifying a time point associated with the video.

25. A system for authenticating video, the system implemented on a computing device of a sending party and comprising:
a processing circuitry; and
a memory in communication with said processing circuitry, the memory containing instructions that, when executed by the processing circuitry, cause the system to:
obtain a reference light pattern identifier, the identifier identifying a light pattern;
using a light source in communication with the computing device of the sending party, generate and project the light pattern identified by the identifier onto an area covered by a camera;
using the camera, capture the area while being projected with the light pattern in a video; and
send the video to a receiving party.

26. The system of claim 25, wherein when executed by the processing circuitry, the instructions further cause the system to query a server computer of a trusted third party, for the reference light pattern identifier.

27. The system of claim 25, wherein when executed by the processing circuitry, the instructions further cause the system to query a server computer of a trusted third party, for the reference light pattern identifier, using data identifying a time point associated with the video.

28. The system of claim 25, wherein when executed by the processing circuitry, the instructions further cause the system to obtain the reference light pattern identifier, using light pattern identifier selector used locally by the sending party.

29. The system of claim 25, wherein when executed by the processing circuitry, the instructions further cause the system to obtain the reference light pattern identifier, using a pattern identifier selector used locally by the sending party and data identifying a time point associated with the video.

30. The system of claim 25, wherein when executed by the processing circuitry, the instructions further cause the system to send the video with data identifying a time point associated with the video.

31. A non-transitory computer readable medium having stored thereon instructions for causing a processing circuitry of a computing device of a sending party to perform a process of authenticating video, the process comprising:
obtaining a reference light pattern identifier, the identifier identifying a light pattern;
using a light source in communication with the computing device of the sending party, generating and projecting the light pattern identified by the identifier, onto an area covered by a camera;
using the camera, capturing the area while being projected with the light pattern in a video; and
sending the video to a receiving party.

32. A method of authenticating video, the method comprising steps performed by a server computer, the steps comprising:
from a computing device of a first party, receiving a first request for an identifier, the identifier identifying a light pattern;
selecting an identifier for the first party, based on the received first request;
providing the computing device of the first party with the selected identifier, for the first party to use for generating and projecting the light pattern onto an area while being captured in a video;
from a computing device of a second party, the second party being in receipt of the video, receiving a second request for the identifier;
selecting the same identifier for the second party, based on the received second request; and
providing the computing device of the second party with the selected identifier, for the second party to use for verifying authenticity of the video.

33. A system for authenticating video, the system implemented on a server computer and comprising:
a processing circuitry; and
a memory in communication with said processing circuitry, the memory containing instructions that, when executed by the processing circuitry, cause the system to:
from a computing device of a first party, receive a first request for an identifier, the identifier identifying a light pattern;
select an identifier for the first party, based on the received first request;
provide the computing device of the first party with the selected identifier, for the first party to use for generating and projecting the light pattern onto an area while being captured in a video;
from a computing device of a second party, the second party being in receipt of the video, receive a second request for the identifier;
select the same identifier for the second party, based on the received second request; and
provide the computing device of the second party with the selected identifier, for the second party to use for verifying authenticity of the video.

34. A non-transitory computer readable medium having stored thereon instructions for causing a processing circuitry of a server computer to perform a process of authenticating video, the process comprising:
from a computing device of a first party, receiving a first request for an identifier, the identifier identifying a light pattern;
selecting an identifier for the first party, based on the received first request;
providing the computing device of the first party with the selected identifier, for the first party to use for generating and projecting the light pattern onto an area while being captured in a video;
from a computing device of a second party, the second party being in receipt of the video, receiving a second request for the identifier;
selecting the same identifier for the second party, based on the received second request; and
providing the computing device of the second party with the selected identifier, for the second party to use for verifying authenticity of the video.
